(19) United States
(12) Patent Application Publication
(10) Pub. No.: US 2014/0045890 A1
(43) Pub. Date: Feb. 13, 2014

(54) NOVEL COMPOUNDS

(71) Applicants: Guillaume Berthon, Stein (CH); Fiona Kessabi Murphy, Stein (CH); Renaud Beaudegnies, Stein (CH); Clemens Lamberth, Stein (CH); Laura Quaranta, Stein (CH); Stephan Trah, Stein (CH)

(72) Inventors: Guillaume Berthon, Stein (CH); Fiona Kessabi Murphy, Stein (CH); Renaud Beaudegnies, Stein (CH); Clemens Lamberth, Stein (CH); Laura Quaranta, Stein (CH); Stephan Trah, Stein (CH)

(73) Assignee: SYNGENTA PARTICIPATIONS AG, Basel (CH)

(21) Appl. No.: 14/007,355

(22) PCT Filed: Mar. 28, 2012
(86) PCT No.: PCT/EP2012/055578

§ 371 Date: Nov. 1, 2013

(30) Foreign Application Priority Data
Mar. 31, 2011 (EP) 1160646.3

(51) Int. Cl. A01N 43/80; A01N 43/42

(52) U.S. Cl. CPC A01N 43/80; A01N 43/42
USPC 514/314; 546/175

(57) ABSTRACT

Compounds of the general formula (I) wherein the substituents are as defined in claim 1, are useful as fungicides.

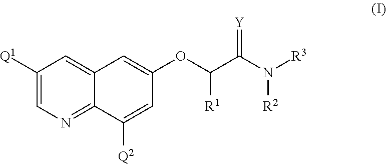

This invention relates to novel acid amides, processes for preparing them, to compositions containing them and to methods of using them to combat fungi, especially fungal infections of plants.

Certain acid amide derivatives and their use as fungicides are disclosed, for example, in WO08/110,355, WO09/030,467, WO09/030,469 and WO09/049,716.

The present invention is concerned with the provision of particular substituted acid amides for use mainly as plant fungicides.

Thus, according to the present invention there is provided a compound of the general formula (I)

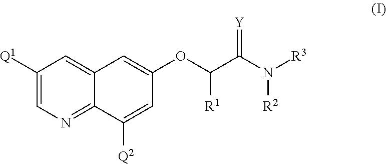

wherein
Q¹ is methyl, ethyl, cyclopropyl, methoxy, methylthio, vinyl, ethynyl, bromo, iodo or thienyl;
Q² is hydrogen, methyl, fluoro or chloro;
R¹ is ethyl, methoxy or methylthio;
R² is hydrogen or methyl;

### R³ is —CR⁴R⁵R⁶;

R⁴ and R⁵, independently of each other, are hydrogen, methyl, ethyl, methoxymethyl or cyano,
R⁴ and R⁵ together with the carbon atom to which they are attached form a 3- to 5-membered carbocyclic ring, which is optionally substituted by methyl;
R⁶ is a heteroaryl selected from the group consisting of oxazolyl, isoxazolyl, benzoxazolyl, thiazolyl, isothiazolyl and pyridyl, which heteroaryls are unsubstituted or substituted by C₁₋₄alkyl, C₁₋₄haloalkyl, C₁₋₄hydroxyalkyl, C₁₋₄methoxyalkyl, C₁₋₄alkoxy, phenyl, C₁₋₄-alkoxycarbonyl, halogen or tri(C₁₋₄alkyl)silyl, where when Q¹ is bromo or iodo and R¹ is ethyl or methoxy then R⁶ is different from pyridyl; and
Y is oxygen or sulfur;
or a salt or a N-oxide thereof.

The compounds of the invention contain at least one asymmetric carbon atom and therefore may exist as enantiomers, as pairs of diastereoisomers or as mixtures of such.

Compounds of general formula (I) can therefore exist as racemates, diastereoisomers, or single enantiomers, and the invention includes all possible isomers or isomer mixtures in all proportions. It is to be expected that for any given compound, one isomer may be more fungicidally active than another.

The salts which the compounds of the formula I can form are preferably those formed by interaction of these compounds with acids. The term “acid” comprises mineral acids such as hydrogen halides, sulphuric acid, phosphoric acid etc. as well as organic acids, preferably the commonly used alkanoic acids, for example formic acid, acetic acid and propionic acid.

The carbocyclic rings preferably contain 3 to 5 carbon atoms and are cyclopropyl, cyclobutyl or cyclopentyl. Cyclopropyl is particularly preferred.

Optional substituents on the heteroaryl are C₁₋₄alkyl, C₁₋₄haloalkyl, C₁₋₄hydroxyalkyl, C₁₋₄-methoxyalkyl, C₁₋₄alkoxy, phenyl, C₁₋₄-alkoxycarbonyl, halogen and tri(C₁₋₄alkyl)silyl, preferably methyl, ethyl, trifluoromethyl, hydroxymethyl, methoxy, ethoxy, phenyl, methoxymethyl, methoxycarbonyl, fluoro, chloro, bromo or iodo, and trimethylsilyl, where methyl, trifluoromethyl, chloro and bromo are particularly preferred.

Other optional substituents on the heteroaryl are cyano, C₁₋₄haloalcoxy C₂₋₄alkenyl, and C₂₋₄alkynyl.

A link of the —CR⁴R⁵— group to a heteroaryl group can be via a carbon atom or via a nitrogen atom.

Of particular interest are those compounds of the formula I, wherein Q¹ is methylthio, vinyl, ethynyl, iodo, in particular ethynyl.

Q² is preferably hydrogen and methyl.

R¹ is preferably methoxy or methylthio, more preferably methylthio.

R² is preferably hydrogen.

R⁴ and R⁵, independently of each other, are preferably hydrogen, methyl or ethyl.

R⁶ is preferably thiazolyl, isothiazolyl, isoxazolyl and pyridyl, more preferably isoxazolyl and pyridyl and in particular isoxazolyl.

Y is preferably oxygen.

In another preferred group of compounds of formula I, Q¹ is methylthio, vinyl, ethynyl, bromo, iodo or thienyl; Q² is hydrogen, methyl, fluoro or chloro; R¹ is ethyl, methoxy or methylthio; R² is hydrogen; R³ is —CR⁴R⁵R⁶; R⁴ and R⁵, independently of each other, are hydrogen, methyl or ethyl, R⁴ and R⁵ together with the carbon atom to which they are attached form a cyclopropyl group; and R⁶ is a heteroaryl selected from the group consisting of oxazolyl, isoxazolyl, benzoxazolyl, thiazolyl, isothiazolyl and pyridyl, which heteroaryls are unsubstituted or substituted by methyl, ethyl, trifluormethyl, hydroxymethyl, methoxymethyl, methoxy, ethoxy, phenyl, methoxycarbonyl, halogen or trimethylsilyl.

In another preferred group of compounds of formula I Q¹ is methylthio, vinyl, ethynyl or iodo; Q² is hydrogen, methyl, chloro or fluoro; R¹ is methylthio; R² is hydrogen; R³ is —CR⁴R⁵R⁶; R⁴ and R⁵, independently of each other, are hydrogen, methyl or ethyl, and R⁶ is a heteroaryl selected from the group consisting of isoxazolyl, thiazolyl, isothiazolyl and pyridyl.

In another preferred group of compounds of formula I Q¹ is methylthio, vinyl, ethynyl or iodo; Q² is hydrogen, methyl, chloro or fluoro; R¹ is methoxy; R² is hydrogen; R³ is —CR⁴R⁵R⁶; R⁴ and R⁵, independently of each other, are hydrogen, methyl or ethyl, and R⁶ is R⁶ is a heteroaryl selected from the group consisting of isoxazolyl, thiazolyl, isothiazolyl and pyridyl.

Compounds that form part of the invention are illustrated in Tables 1 to 48 below.

Compounds of the formula I:

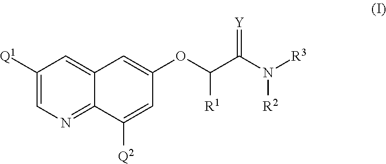

TABLE 1
The compounds of Table 1 are of the general formula (I) where
Q¹ is vinyl, Q² is hydrogen, Y is oxygen, R¹ is ethyl, R² is hydrogen
and R³ (i.e. —CR⁴R⁵R⁶) has the values given in the table.

| Compound No. | R⁴ | R⁵ | R⁶ |
|---|---|---|---|
| 1 | H | H | 2-pyridyl |
| 2 | H | CH₃ | 2-pyridyl |
| 3 | CH₃ | CH₃ | 2-pyridyl |
| 4 | H | CH₂CH₃ | 2-pyridyl |
| 5 | CH₃ | CH₂CH₃ | 2-pyridyl |
| 6 | CH₂CH₂ | | 2-pyridyl |
| 7 | H | H | 2-(6-methylpyridyl) |
| 8 | H | CH₃ | 2-(6-methylpyridyl) |
| 9 | CH₃ | CH₃ | 2-(6-methylpyridyl) |
| 10 | H | CH₂CH₃ | 2-(6-methylpyridyl) |
| 11 | CH₃ | CH₂CH₃ | 2-(6-methylpyridyl) |
| 12 | CH₂CH₂ | | 2-(6-methylpyridyl) |
| 13 | H | H | 2-(4-methylpyridyl) |
| 14 | H | CH₃ | 2-(4-methylpyridyl) |
| 15 | CH₃ | CH₃ | 2-(4-methylpyridyl) |
| 16 | H | CH₂CH₃ | 2-(4-methylpyridyl) |
| 17 | CH₃ | CH₂CH₃ | 2-(4-methylpyridyl) |
| 18 | CH₂CH₂ | | 2-(4-methylpyridyl) |
| 19 | H | H | 3-pyridyl |
| 20 | H | CH₃ | 3-pyridyl |
| 21 | CH₃ | CH₃ | 3-pyridyl |
| 22 | H | CH₂CH₃ | 3-pyridyl |
| 23 | CH₃ | CH₂CH₃ | 3-pyridyl |
| 24 | CH₂CH₂ | | 3-pyridyl |
| 25 | H | H | 3-(6-chloropyridyl) |
| 26 | H | CH₃ | 3-(6-chloropyridyl) |
| 27 | CH₃ | CH₃ | 3-(6-chloropyridyl) |
| 28 | H | CH₂CH₃ | 3-(6-chloropyridyl) |
| 29 | CH₃ | CH₂CH₃ | 3-(6-chloropyridyl) |
| 30 | CH₂CH₂ | | 3-(6-chloropyridyl) |
| 31 | H | H | 4-pyridyl |
| 32 | H | CH₃ | 4-pyridyl |
| 33 | CH₃ | CH₃ | 4-pyridyl |
| 34 | H | CH₂CH₃ | 4-pyridyl |
| 35 | CH₃ | CH₂CH₃ | 4-pyridyl |
| 36 | CH₂CH₂ | | 4-pyridyl |
| 37 | H | H | 2-thiazolyl |
| 38 | H | CH₃ | 2-thiazolyl |
| 39 | CH₃ | CH₃ | 2-thiazolyl |
| 40 | H | CH₂CH₃ | 2-thiazolyl |
| 41 | CH₃ | CH₂CH₃ | 2-thiazolyl |
| 42 | CH₂CH₂ | | 2-thiazolyl |
| 43 | H | H | 2-(5-methylthiazolyl) |
| 44 | H | CH₃ | 2-(5-methylthiazolyl) |
| 45 | CH₃ | CH₃ | 2-(5-methylthiazolyl) |
| 46 | H | CH₂CH₃ | 2-(5-methylthiazolyl) |
| 47 | CH₃ | CH₂CH₃ | 2-(5-methylthiazolyl) |
| 48 | CH₂CH₂ | | 2-(5-methylthiazolyl) |
| 49 | H | H | 2-(4-methylthiazolyl) |
| 50 | H | CH₃ | 2-(4-methylthiazolyl) |
| 51 | CH₃ | CH₃ | 2-(4-methylthiazolyl) |
| 52 | H | CH₂CH₃ | 2-(4-methylthiazolyl) |
| 53 | CH₃ | CH₂CH₃ | 2-(4-methylthiazolyl) |
| 54 | CH₂CH₂ | | 2-(4-methylthiazolyl) |
| 55 | H | H | 2-(4,5-dimethylthiazolyl) |
| 56 | H | CH₃ | 2-(4,5-dimethylthiazolyl) |
| 57 | CH₃ | CH₃ | 2-(4,5-dimethylthiazolyl) |
| 58 | H | CH₂CH₃ | 2-(4,5-dimethylthiazolyl) |
| 59 | CH₃ | CH₂CH₃ | 2-(4,5-dimethylthiazolyl) |
| 60 | CH₂CH₂ | | 2-(4,5-dimethylthiazolyl) |
| 61 | H | H | 2-(4-chlorothiazolyl) |
| 62 | H | CH₃ | 2-(4-chlorothiazolyl) |
| 63 | CH₃ | CH₃ | 2-(4-chlorothiazolyl) |
| 64 | H | CH₂CH₃ | 2-(4-chlorothiazolyl) |
| 65 | CH₃ | CH₂CH₃ | 2-(4-chlorothiazolyl) |
| 66 | CH₂CH₂ | | 2-(4-chlorothiazolyl) |
| 67 | H | H | 3-thiazolyl |
| 68 | H | CH₃ | 3-thiazolyl |
| 69 | CH₃ | CH₃ | 3-thiazolyl |
| 70 | H | CH₂CH₃ | 3-thiazolyl |
| 71 | CH₃ | CH₂CH₃ | 3-thiazolyl |
| 72 | CH₂CH₂ | | 3-thiazolyl |
| 73 | H | H | 2-isothiazolyl |
| 74 | H | CH₃ | 2-isothiazolyl |
| 75 | CH₃ | CH₃ | 2-isothiazolyl |
| 76 | H | CH₂CH₃ | 2-isothiazolyl |
| 77 | CH₃ | CH₂CH₃ | 2-isothiazolyl |
| 78 | CH₂CH₂ | | 2-isothiazolyl |
| 79 | H | H | 2-(3-methoxycarbonylisothiazolyl) |
| 80 | H | CH₃ | 2-(3-methoxycarbonylisothiazolyl) |
| 81 | CH₃ | CH₃ | 2-(3-methoxycarbonylisothiazolyl) |
| 82 | H | CH₂CH₃ | 2-(3-methoxycarbonylisothiazolyl) |
| 83 | CH₃ | CH₂CH₃ | 2-(3-methoxycarbonylisothiazolyl) |
| 84 | CH₂CH₂ | | 2-(3-methoxycarbonylisothiazolyl) |
| 85 | H | H | 2-(4-methoxycarbonylisothiazolyl) |
| 86 | H | CH₃ | 2-(4-methoxycarbonylisothiazolyl) |
| 87 | CH₃ | CH₃ | 2-(4-methoxycarbonylisothiazolyl) |
| 88 | H | CH₂CH₃ | 2-(4-methoxycarbonylisothiazolyl) |
| 89 | CH₃ | CH₂CH₃ | 2-(4-methoxycarbonylisothiazolyl) |
| 90 | CH₂CH₂ | | 2-(4-methoxycarbonylisothiazolyl) |
| 91 | H | H | 3-isoxazolyl |
| 92 | H | CH₃ | 3-isoxazolyl |
| 93 | CH₃ | CH₃ | 3-isoxazolyl |
| 94 | H | CH₂CH₃ | 3-isoxazolyl |
| 95 | CH₃ | CH₂CH₃ | 3-isoxazolyl |
| 96 | CH₂CH₂ | | 3-isoxazolyl |
| 97 | H | H | 5-isoxazolyl |
| 98 | H | CH₃ | 5-isoxazolyl |
| 99 | CH₃ | CH₃ | 5-isoxazolyl |
| 100 | H | CH₂CH₃ | 5-isoxazolyl |
| 101 | CH₃ | CH₂CH₃ | 5-isoxazolyl |
| 102 | CH₂CH₂ | | 5-isoxazolyl |
| 103 | H | H | 3-(4-methylisoxazolyl) |
| 104 | H | CH₃ | 3-(4-methylisoxazolyl) |
| 105 | CH₃ | CH₃ | 3-(4-methylisoxazolyl) |
| 106 | H | CH₂CH₃ | 3-(4-methylisoxazolyl) |
| 107 | CH₃ | CH₂CH₃ | 3-(4-methylisoxazolyl) |
| 108 | CH₂CH₂ | | 3-(4-methylisoxazolyl) |
| 109 | H | H | 3-(5-methylisoxazolyl) |
| 110 | H | CH₃ | 3-(5-methylisoxazolyl) |
| 111 | CH₃ | CH₃ | 3-(5-methylisoxazolyl) |
| 112 | H | CH₂CH₃ | 3-(5-methylisoxazolyl) |
| 113 | CH₃ | CH₂CH₃ | 3-(5-methylisoxazolyl) |
| 114 | CH₂CH₂ | | 3-(5-methylisoxazolyl) |
| 115 | H | H | 3-(5-ethylisoxazolyl) |
| 116 | H | CH₃ | 3-(5-ethylisoxazolyl) |
| 117 | CH₃ | CH₃ | 3-(5-ethylisoxazolyl) |
| 118 | H | CH₂CH₃ | 3-(5-ethylisoxazolyl) |
| 119 | CH₃ | CH₂CH₃ | 3-(5-ethylisoxazolyl) |
| 120 | CH₂CH₂ | | 3-(5-ethylisoxazolyl) |
| 121 | H | H | 3-(5-chloroisoxazolyl) |
| 122 | H | CH₃ | 3-(5-chloroisoxazolyl) |
| 123 | CH₃ | CH₃ | 3-(5-chloroisoxazolyl) |
| 124 | H | CH₂CH₃ | 3-(5-chloroisoxazolyl) |
| 125 | CH₃ | CH₂CH₃ | 3-(5-chloroisoxazolyl) |
| 126 | CH₂CH₂ | | 3-(5-chloroisoxazolyl) |
| 127 | H | H | 3-(5-methoxymethylisoxazolyl) |
| 128 | H | CH₃ | 3-(5-methoxymethylisoxazolyl) |
| 129 | CH₃ | CH₃ | 3-(5-methoxymethylisoxazolyl) |
| 130 | H | CH₂CH₃ | 3-(5-methoxymethylisoxazolyl) |
| 131 | CH₃ | CH₂CH₃ | 3-(5-methoxymethylisoxazolyl) |
| 132 | CH₂CH₂ | | 3-(5-methoxymethylisoxazolyl) |
| 133 | H | H | 3-(5-methoxycarbonylisoxazolyl) |
| 134 | H | CH₃ | 3-(5-methoxycarbonylisoxazolyl) |
| 135 | CH₃ | CH₃ | 3-(5-methoxycarbonylisoxazolyl) |
| 136 | H | CH₂CH₃ | 3-(5-methoxycarbonylisoxazolyl) |
| 137 | CH₃ | CH₂CH₃ | 3-(5-methoxycarbonylisoxazolyl) |
| 138 | CH₂CH₂ | | 3-(5-methoxycarbonylisoxazolyl) |
| 139 | H | H | 3-(5-trifluoromethyisoxazolyl) |
| 140 | H | CH₃ | 3-(5-trifluoromethyisoxazolyl) |
| 141 | CH₃ | CH₃ | 3-(5-trifluoromethyisoxazolyl) |
| 142 | H | CH₂CH₃ | 3-(5-trifluoromethyisoxazolyl) |
| 143 | CH₃ | CH₂CH₃ | 3-(5-trifluoromethyisoxazolyl) |
| 144 | CH₂CH₂ | | 3-(5-trifluoromethyisoxazolyl) |
| 145 | H | H | 3-(5-hydroxymethylisoxazolyl) |
| 146 | H | CH₃ | 3-(5-hydroxymethylisoxazolyl) |
| 147 | CH₃ | CH₃ | 3-(5-hydroxymethylisoxazolyl) |
| 148 | H | CH₂CH₃ | 3-(5-hydroxymethylisoxazolyl) |
| 149 | CH₃ | CH₂CH₃ | 3-(5-hydroxymethylisoxazolyl) |
| 150 | CH₂CH₂ | | 3-(5-hydroxymethylisoxazolyl) |
| 151 | H | H | 1,2-benzoxazol-3-yl |
| 152 | H | CH₃ | 1,2-benzoxazol-3-yl |
| 153 | CH₃ | CH₃ | 1,2-benzoxazol-3-yl |
| 154 | H | CH₂CH₃ | 1,2-benzoxazol-3-yl |
| 155 | CH₃ | CH₂CH₃ | 1,2-benzoxazol-3-yl |
| 156 | CH₂CH₂ | | 1,2-benzoxazol-3-yl |
| 157 | H | H | 3-(4-chloroisoxazolyl) |
| 158 | H | CH₃ | 3-(4-chloroisoxazolyl) |
| 159 | CH₃ | CH₃ | 3-(4-chloroisoxazolyl) |
| 160 | H | CH₂CH₃ | 3-(4-chloroisoxazolyl) |
| 161 | CH₃ | CH₂CH₃ | 3-(4-chloroisoxazolyl) |
| 162 | CH₂CH₂ | | 3-(4-chloroisoxazolyl) |
| 163 | H | H | 3-(4-bromoisoxazolyl) |
| 164 | H | CH₃ | 3-(4-bromoisoxazolyl) |
| 165 | CH₃ | CH₃ | 3-(4-bromoisoxazolyl) |
| 166 | H | CH₂CH₃ | 3-(4-bromoisoxazolyl) |
| 167 | CH₃ | CH₂CH₃ | 3-(4-bromoisoxazolyl) |
| 168 | CH₂CH₂ | | 3-(4-bromoisoxazolyl) |
| 169 | H | H | 3-(4-iodoisoxazolyl) |
| 170 | H | CH₃ | 3-(4-iodoisoxazolyl) |
| 171 | CH₃ | CH₃ | 3-(4-iodoisoxazolyl) |
| 172 | H | CH₂CH₃ | 3-(4-iodoisoxazolyl) |
| 173 | CH₃ | CH₂CH₃ | 3-(4-iodoisoxazolyl) |
| 174 | CH₂CH₂ | | 3-(4-iodoisoxazolyl) |
| 175 | H | H | 3-(4-iodoisoxazolyl) |
| 181 | H | H | 3-(5,5-dimethyl-4H-isoxazolyl) |
| 182 | H | CH₃ | 3-(5,5-dimethyl-4H-isoxazolyl) |
| 183 | CH₃ | CH₃ | 3-(5,5-dimethyl-4H-isoxazolyl) |
| 184 | H | CH₂CH₃ | 3-(5,5-dimethyl-4H-isoxazolyl) |
| 185 | CH₃ | CH₂CH₃ | 3-(5,5-dimethyl-4H-isoxazolyl) |
| 186 | CH₂CH₂ | | 3-(5,5-dimethyl-4H-isoxazolyl) |
| 187 | H | H | 3-(5-trifluoromethyl-4H-isoxazolyl) |
| 188 | H | CH₃ | 3-(5-trifluoromethyl-4H-isoxazolyl) |
| 189 | CH₃ | CH₃ | 3-(5-trifluoromethyl-4H-isoxazolyl) |
| 190 | H | CH₂CH₃ | 3-(5-trifluoromethyl-4H-isoxazolyl) |
| 191 | CH₃ | CH₂CH₃ | 3-(5-trifluoromethyl-4H-isoxazolyl) |
| 192 | CH₂CH₂ | | 3-(5-trifluoromethyl-4H-isoxazolyl) |
| 211 | H | H | (2-oxo-1,3,4-oxathiazol-5-yl) |
| 212 | H | CH₃ | (2-oxo-1,3,4-oxathiazol-5-yl) |
| 213 | CH₃ | CH₃ | (2-oxo-1,3,4-oxathiazol-5-yl) |
| 214 | H | CH₂CH₃ | (2-oxo-1,3,4-oxathiazol-5-yl) |
| 215 | CH₃ | CH₂CH₃ | (2-oxo-1,3,4-oxathiazol-5-yl) |

| | | |
|---|---|---|
| 216 | CH₂CH₂ | (2-oxo-1,3,4-oxathiazol-5-yl) |

### Table 2

The compounds of Table 2 are of the general formula (I) where Q¹ is vinyl, Q² is fluoro, Y is oxygen, R¹ is ethyl, R² is hydrogen and R³ has the values given in Table 1.

### Table 3

The compounds of Table 3 are of the general formula (I) where Q¹ is vinyl, Q² is chloro, Y is oxygen, R¹ is ethyl, R² is hydrogen and R³ has the values given in Table 1.

### Table 4

The compounds of Table 4 are of the general formula (I) where Q¹ is vinyl, Q² is methyl, Y is oxygen, R¹ is ethyl, R² is hydrogen and R³ has the values given in Table 1.

### Table 5

The compounds of Table 5 are of the general formula (I) where Q¹ is vinyl, Q² is hydrogen, Y is oxygen, R¹ is methoxy, R² is hydrogen and R³ has the values given in Table 1.

### Table 6

The compounds of Table 6 are of the general formula (I) where Q¹ is vinyl, Q² is fluoro, Y is oxygen, R¹ is methoxy, R² is hydrogen and R³ has the values given in Table 1.

### Table 7

The compounds of Table 7 are of the general formula (I) where Q¹ is vinyl, Q² is chloro, Y is oxygen, R¹ is methoxy, R² is hydrogen and R³ has the values given in Table 1.

### Table 8

The compounds of Table 8 are of the general formula (I) where Q¹ is vinyl, Q² is methyl, Y is oxygen, R¹ is methoxy, R² is hydrogen and R³ has the values given in Table 1.

### Table 9

The compounds of Table 9 are of the general formula (I) where Q¹ is vinyl, Q² is hydrogen, Y is oxygen, R¹ is methylthio, R² is hydrogen and R³ has the values given in Table 1.

### Table 10

The compounds of Table 10 are of the general formula (I) where Q¹ is vinyl, Q² is fluoro, Y is oxygen, R¹ is methylthio, R² is hydrogen and R³ has the values given in Table 1.

### Table 11

The compounds of Table 11 are of the general formula (I) where Q¹ is vinyl, Q² is chloro, Y is oxygen, R¹ is methylthio, R² is hydrogen and R³ has the values given in Table 1.

### Table 12

The compounds of Table 12 are of the general formula (I) where Q¹ is vinyl, Q² is methyl, Y is oxygen, R¹ is methylthio, R² is hydrogen and R³ has the values given in Table 1.

### Table 13

The compounds of Table 13 are of the general formula (I) where Q¹ is iodo, Q² is hydrogen, Y is oxygen, R¹ is ethyl, R² is hydrogen and R³ has the values given in Table 1.

### Table 14

The compounds of Table 14 are of the general formula (I) where Q¹ is iodo, Q² is fluoro, Y is oxygen, R¹ is ethyl, R² is hydrogen and R³ has the values given in Table 1.

### Table 15

The compounds of Table 15 are of the general formula (I) where Q¹ is iodo, Q² is chloro, Y is oxygen, R¹ is ethyl, R² is hydrogen and R³ has the values given in Table 1.

### Table 16

The compounds of Table 16 are of the general formula (I) where Q¹ is iodo, Q² is methyl, Y is oxygen, R¹ is ethyl, R² is hydrogen and R³ has the values given in Table 1.

### Table 17

The compounds of Table 17 are of the general formula (I) where Q¹ is iodo, Q² is hydrogen, Y is oxygen, R¹ is methoxy, R² is hydrogen and R³ has the values given in Table 1.

### Table 18

The compounds of Table 18 are of the general formula (I) where Q¹ is iodo, Q² is fluoro, Y is oxygen, R¹ is methoxy, R² is hydrogen and R³ has the values given in Table 1.

### Table 19

The compounds of Table 19 are of the general formula (I) where Q¹ is iodo, Q² is chloro, Y is oxygen, R¹ is methoxy, R² is hydrogen and R³ has the values given in Table 1.

### Table 20

The compounds of Table 20 are of the general formula (I) where Q¹ is iodo, Q² is methyl, Y is oxygen, R¹ is methoxy, R² is hydrogen and R³ has the values given in Table 1.

### Table 21

The compounds of Table 21 are of the general formula (I) where Q¹ is iodo, Q² is hydrogen, Y is oxygen, R¹ is methylthio, R² is hydrogen and R³ has the values given in Table 1.

### Table 22

The compounds of Table 22 are of the general formula (I) where Q¹ is iodo, Q² is fluoro, Y is oxygen, R¹ is methylthio, R² is hydrogen and R³ has the values given in Table 1.

### Table 23

The compounds of Table 23 are of the general formula (I) where Q¹ is iodo, Q² is chloro, Y is oxygen, R¹ is methylthio, R² is hydrogen and R³ has the values given in Table 1.

### Table 24

The compounds of Table 24 are of the general formula (I) where Q¹ is iodo, Q² is methyl, Y is oxygen, R¹ is methylthio, R² is hydrogen and R³ has the values given in Table 1.

### Table 25

The compounds of Table 25 are of the general formula (I) where Q¹ is ethynyl, Q² is hydrogen, Y is oxygen, R¹ is ethyl, R² is hydrogen and R³ has the values given in Table 1.

### Table 26

The compounds of Table 26 are of the general formula (I) where Q¹ is ethynyl, Q² is fluoro, Y is oxygen, R¹ is ethyl, R² is hydrogen and R³ has the values given in Table 1.

### Table 27

The compounds of Table 27 are of the general formula (I) where Q¹ is ethynyl, Q² is chloro, Y is oxygen, R¹ is ethyl, R² is hydrogen and R³ has the values given in Table 1.

### Table 28

The compounds of Table 28 are of the general formula (I) where Q¹ is ethynyl, Q² is methyl, Y is oxygen, R¹ is ethyl, R² is hydrogen and R³ has the values given in Table 1.

### Table 29

The compounds of Table 29 are of the general formula (I) where Q¹ is ethynyl, Q² is hydrogen, Y is oxygen, R¹ is methoxy, R² is hydrogen and R³ has the values given in Table 1.

### Table 30

The compounds of Table 30 are of the general formula (I) where Q¹ is ethynyl, Q² is fluoro, Y is oxygen, R¹ is methoxy, R² is hydrogen and R³ has the values given in Table 1.

### Table 31

The compounds of Table 31 are of the general formula (I) where Q¹ is ethynyl, Q² is chloro, Y is oxygen, R¹ is methoxy, R² is hydrogen and R³ has the values given in Table 1.

### Table 32

The compounds of Table 32 are of the general formula (I) where Q¹ is ethynyl, Q² is methyl, Y is oxygen, R¹ is methoxy, R² is hydrogen and R³ has the values given in Table 1.

### Table 33

The compounds of Table 33 are of the general formula (I) where Q¹ is ethynyl, Q² is hydrogen, Y is oxygen, R¹ is methylthio, R² is hydrogen and R³ has the values given in Table 1.

### Table 34

The compounds of Table 34 are of the general formula (I) where Q¹ is ethynyl, Q² is fluoro, Y is oxygen, R¹ is methylthio, R² is hydrogen and R³ has the values given in Table 1.

### Table 35

The compounds of Table 35 are of the general formula (I) where Q¹ is ethynyl, Q² is chloro, Y is oxygen, R¹ is methylthio, R² is hydrogen and R³ has the values given in Table 1.

### Table 36

The compounds of Table 36 are of the general formula (I) where Q¹ is ethynyl, Q² is methyl, Y is oxygen, R¹ is methylthio, R² is hydrogen and R³ has the values given in Table 1.

### Table 37

The compounds of Table 37 are of the general formula (I) where Q¹ is methylthio, Q² is hydrogen, Y is oxygen, R¹ is ethyl, R² is hydrogen and R³ has the values given in Table 1.

### Table 38

The compounds of Table 38 are of the general formula (I) where Q¹ is methylthio, Q² is fluoro, Y is oxygen, R¹ is ethyl, R² is hydrogen and R³ has the values given in Table 1.

### Table 39

The compounds of Table 39 are of the general formula (I) where Q¹ is methylthio, Q² is chloro, Y is oxygen, R¹ is ethyl, R² is hydrogen and R³ has the values given in Table 1.

### Table 40

The compounds of Table 40 are of the general formula (I) where Q¹ is methylthio, Q² is methyl, Y is oxygen, R¹ is ethyl, R² is hydrogen and R³ has the values given in Table 1.

### Table 41

The compounds of Table 41 are of the general formula (I) where Q¹ is methylthio, Q² is hydrogen, Y is oxygen, R¹ is methoxy, R² is hydrogen and R³ has the values given in Table 1.

### Table 42

The compounds of Table 42 are of the general formula (I) where Q¹ is methylthio, Q² is fluoro, Y is oxygen, R¹ is methoxy, R² is hydrogen and R³ has the values given in Table 1.

### Table 43

The compounds of Table 43 are of the general formula (I) where Q¹ is methylthio, Q² is chloro, Y is oxygen, R¹ is methoxy, R² is hydrogen and R³ has the values given in Table 1.

### Table 44

The compounds of Table 44 are of the general formula (I) where Q¹ is methylthio, Q² is methyl, Y is oxygen, R¹ is methoxy, R² is hydrogen and R³ has the values given in Table 1.

### Table 45

The compounds of Table 45 are of the general formula (I) where Q¹ is methylthio, Q² is hydrogen, Y is oxygen, R¹ is methylthio, R² is hydrogen and R³ has the values given in Table 1.

### Table 46

The compounds of Table 46 are of the general formula (I) where Q¹ is methylthio, Q² is fluoro, Y is oxygen, R¹ is methylthio, R² is hydrogen and R³ has the values given in Table 1.

### Table 47

The compounds of Table 47 are of the general formula (I) where Q¹ is methylthio, Q² is chloro, Y is oxygen, R¹ is methylthio, R² is hydrogen and R³ has the values given in Table 1.

### Table 48

The compounds of Table 48 are of the general formula (I) where Q¹ is methylthio, Q² is methyl, Y is oxygen, R¹ is methylthio, R² is hydrogen and R³ has the values given in Table 1.

The compounds of formula (I) may be prepared in an analogous manner as outlined in WO08/110,355, WO09/030,467, WO09/030,469 and WO09/049,716 by chemical reactions known in the art.

The compounds of formula (I) are active fungicides and may be used to control one or more of the following pathogens: Pyricularia oryzae (Magnaporthe grisea) on rice and wheat and other Pyricularia spp. on other hosts; Puccinia triticina (or recondita), Puccinia striiformis and other rusts on wheat, Puccinia hordei, Puccinia striiformis and other rusts on barley, and rusts on other hosts (for example turf, rye, coffee, pears, apples, peanuts, sugar beet, vegetables and ornamental plants); Phakopsora pachyrhizi on soybean, Erysiphe cichoracearum on cucurbits (for example melon); Blumeria (or Erysiphe) graminis (powdery mildew) on barley, wheat, rye and turf and other powdery mildews on various hosts, such as Sphaerotheca macularis on hops, Sphaerotheca fusca (Sphaerotheca fuliginea) on cucurbits (for example cucumber), Leveillula taurica on tomatoes, aubergine and green pepper, Podosphaera leucotricha on apples and Uncinula necator on vines; Cochliobolus spp., Helminthosporium spp., Drechslera spp. (Pyrenophora spp.), Rhynchosporium spp., Mycosphaerella graminicola (Septoria tritici) and Phaeosphaeria nodorum (Stagonospora nodorum or Septoria nodorum), Pseudocercosporella herpotrichoides and Gaeumannomyces graminis on cereals (for example wheat, barley, rye), turf and other hosts; Cercospora arachidicola and Cercosporidium personatum on peanuts and other Cercospora spp. on other hosts, for example sugar beet, bananas, soya beans and rice; Botrytis cinerea (grey mould) on tomatoes, strawberries, vegetables, vines and other hosts and other Botrytis spp. on other hosts; Alternaria spp. on vegetables (for example carrots), oil-seed rape, apples, tomatoes, potatoes, cereals (for example wheat) and other hosts; Venturia spp. (including Venturia inaequalis (scab)) on apples, pears, stone fruit, tree nuts and other hosts; Cladosporium spp. on a range of hosts including cereals (for example wheat) and tomatoes; Monilinia spp. on stone fruit, tree nuts and other hosts; Didymella spp. on tomatoes, turf, wheat, cucurbits and other hosts; Phoma spp. on oil-seed rape, turf, rice, potatoes, wheat and other hosts; Aspergillus spp. and Aureobasidium spp. on wheat, lumber and other hosts; Ascochyta spp. on peas, wheat, barley and other hosts; Stemphylium spp. (Pleospora spp.) on apples, pears, onions and other hosts; summer diseases (for example bitter rot (Glomerella cingulata), black rot or frogeye leaf spot (Botryosphaeria obtusa), Brooks fruit spot (Mycosphaerella pomi), Cedar apple rust (Gymnosporangium juniperi-virginianae), sooty blotch (Gloeodes pomigena), flyspeck (Schizothyrium pomi) and white rot (Botryosphaeria dothidea)) on apples and pears; Plasmopara viticola on vines; Plasmopara halstedii on sunflower; other downy mildews, such as Bremia lactucae on lettuce, Peronospora spp. on soybeans, tobacco, onions and other hosts, Pseudoperonospora humuli on hops; Peronosclerospora maydis, P. philippinensis and P. sorghi on maize, sorghum and other hosts and Pseudoperonospora cubensis on cucurbits; Pythium spp. (including Pythium ultimum) on cotton, maize, soybean, sugarbeet, vegetables, turf and other hosts; Phytophthora infestans on potatoes and tomatoes and other Phytophthora spp. on vegetables, strawberries, avocado, pepper, ornamentals, tobacco, cocoa and other hosts; Aphanomyces spp. on sugarbeet and other hosts; Thanatephorus cucumeris on rice, wheat, cotton, soybean, maize, sugarbeet and turf and other hosts Rhizoctonia spp. on various hosts such as wheat and barley, peanuts, vegetables, cotton and turf; Sclerotinia spp. on turf, peanuts, potatoes, oil-seed rape and other hosts; Sclerotium spp. on turf, peanuts and other hosts; Gibberella fujikuroi on rice; Colletotrichum spp. on a range of hosts including turf, coffee and vegetables; Laetisaria fuciformis on turf; Mycosphaerella spp. on bananas, peanuts, citrus, pecans, papaya and other hosts; Diaporthe spp. on citrus, soybean, melon, pears, lupin and other hosts; Elsinoe spp. on citrus, vines, olives, pecans, roses and other hosts; Verticillium spp. on a range of hosts including hops, potatoes and tomatoes; Pyrenopeziza spp. on oil-seed rape and other hosts; Oncobasidium theobromae on cocoa causing vascular streak dieback; Fusarium spp. incl. Fusarium culmorum, F. graminearum, F. langsethiae, F. moniliforme, F. proliferatum, F. subglutinans, F. solani and F. oxysporum on wheat, barely, rye, oats, maize, cotton, soybean, sugarbeet and other hosts, Typhula spp., Microdochium nivale, Ustilago spp., Urocystis spp., Tilletia spp. and Claviceps purpurea on a variety of hosts but particularly wheat, barley, turf and maize; Ramularia spp. on sugar beet, barley and other hosts; Thielaviopsis basicola on cotton, vegetables and other hosts; Verticillium spp. on cotton, vegetables and other hosts; post-harvest diseases particularly of fruit (for example Penicillium digitatum, Penicillium italicum and Trichoderma viride on oranges, Colletotrichum musae and Gloeosporium musarum on bananas and Botrytis cinerea on grapes); other pathogens on vines, notably Eutypa lata, Guignardia bidwellii, Phellinus igniarus, Phomopsis viticola, Pseudopeziza tracheiphila and Stereum hirsutum; other pathogens on trees (for example Lophodermium seditiosum) or lumber, notably Cephaloascus fragrans, Ceratocystis spp., Ophiostoma piceae, Penicillium spp., Trichoderma pseudokoningii, Trichoderma viride, Trichoderma harzianum, Aspergillus niger, Leptographium lindbergi and Aureobasidium pullulans; and fungal vectors of viral diseases (for example Polymyxa graminis on cereals as the vector of barley yellow mosaic virus (BYMV) and Polymyxa betae on sugar beet as the vector of rhizomania).

Preferably, the following pathogens are controlled: Pyricularia oryzae (Magnaporthe grisea) on rice and wheat and other Pyricularia spp. on other hosts; Erysiphe cichoracearum on cucurbits (for example melon); Blumeria (or Erysiphe) graminis (powdery mildew) on barley, wheat, rye and turf and other powdery mildews on various hosts, such as Sphaerotheca macularis on hops, Sphaerotheca fusca (Sphaerotheca fuliginea) on cucurbits (for example cucumber), Leveillula taurica on tomatoes, aubergine and green pepper, Podosphaera leucotricha on apples and Uncinula necator on vines; Helminthosporium spp., Drechslera spp. (Pyrenophora spp.), Rhynchosporium spp. Mycosphaerella graminicola (Septoria tritici) and Phaeosphaeria nodorum (Stagonospora nodorum or Septoria nodorum), Pseudocercosporella herpotrichoides and Gaeumannomyces graminis on cereals (for example wheat, barley, rye), turf and other hosts; Cercospora arachidicola and Cercosporidium personatum on peanuts and other Cercospora spp. on other hosts, for example sugar beet, bananas, soya beans and rice; Botrytis cinerea (grey mould) on tomatoes, strawberries, vegetables, vines and other hosts and other Botrytis spp. on other hosts; Alternaria spp. on vegetables (for example carrots), oil-seed rape, apples, tomatoes, potatoes, cereals (for example wheat) and other hosts; Venturia spp. (including Venturia inaequalis (scab)) on apples, pears, stone fruit, tree nuts and other hosts; Cladosporium spp. on a range of hosts including cereals (for example wheat) and tomatoes; Monilinia spp. on stone fruit, tree nuts and other hosts; Didymella spp. on tomatoes, turf, wheat, cucurbits and other hosts; Phoma spp. on oil-seed rape, turf, rice, potatoes, wheat and other hosts; Aspergillus spp. and Aureobasidium spp. on wheat, lumber and other hosts; Ascochyta spp. on peas, wheat, barley and other hosts; Stemphylium spp. (Pleospora spp.) on apples, pears, onions and other hosts; summer diseases (for example bitter rot (Glomerella cingulata), black rot or frogeye leaf spot (Botryosphaeria obtusa), Brooks fruit spot (Mycosphaerella pomi), Cedar apple rust (Gymnosporangium juniperi-virginianae), sooty blotch (Gloeodes pomigena), flyspeck (Schizothyrium pomi) and white rot (Botryosphaeria dothidea)) on apples and pears; Plasmopara viticola on vines; Plasmopara halstedii on sunflower; other downy mildews, such as Bremia lactucae on lettuce, Peronospora spp. on soybeans, tobacco, onions and other hosts, Pseudoperonospora humuli on hops; Peronosclerospora maydis, P. philippinensis and P. sorghi on maize, sorghum and other hosts and Pseudoperonospora cubensis on cucurbits; Pythium spp. (including Pythium ultimum) on cotton, maize, soybean, sugarbeet, vegetables, turf and other hosts; Phytophthora infestans on potatoes and tomatoes and other Phytophthora spp. on vegetables, strawberries, avocado, pepper, ornamentals, tobacco, cocoa and other hosts; Aphanomyces spp. on sugarbeet and other hosts; Thanatephorus cucumeris on rice, wheat, cotton, soybean, maize, sugarbeet and turf and other hosts Rhizoctonia spp. on various hosts such as wheat and barley, peanuts, vegetables, cotton and turf; Sclerotinia spp. on turf, peanuts, potatoes, oil-seed rape and other hosts; Sclerotium spp. on turf, peanuts and other hosts; Gibberella fujikuroi on rice; Colletotrichum spp. on a range of hosts including turf, coffee and vegetables; Laetisaria fuciformis on turf; Mycosphaerella spp. on bananas, peanuts, citrus, pecans, papaya and other hosts; Fusarium spp. incl. Fusarium culmorum, F. graminearum, F. langsethiae, F. moniliforme, F. proliferatum, F. subglutinans, F. solani and F. oxysporum on wheat, barely, rye, oats, maize, cotton, soybean, sugarbeet and other hosts, Microdochium nivale, Ustilago spp., Urocystis spp., Tilletia spp. and Claviceps purpurea on a variety of hosts but particularly wheat, barley, turf and maize; Ramularia spp. on sugar beet, barley and other hosts; Thielaviopsis basicola on cotton, vegetables and other hosts; Verticillium spp. on cotton, vegetables and other hosts; post-harvest diseases particularly of fruit (for example Penicillium digitatum, Penicillium italicum and Trichoderma viride on oranges, Colletotrichum musae and Gloeosporium musarum on bananas and Botrytis cinerea on grapes); other pathogens on vines, notably Eutypa lata, Guignardia bidwellii, Phellinus igniarus, Phomopsis viticola, Pseudopeziza tracheiphila and Stereum hirsutum; other pathogens on trees (for example Lophodermium seditiosum) or lumber, notably Cephaloascus fragrans, Ceratocystis spp., Ophiostoma piceae, Penicillium spp., Trichoderma pseudokoningii, Trichoderma viride, Trichoderma harzianum, Aspergillus niger, Leptographium lindbergi and Aureobasidium pullulans.

More preferably, the following pathogens are controlled: Pyricularia oryzae (Magnaporthe grisea) on rice and wheat and other Pyricularia spp. on other hosts; Erysiphe cichoracearum on cucurbits (for example melon); Blumeria (or Erysiphe) graminis (powdery mildew) on barley, wheat, rye and turf and other powdery mildews on various hosts, such as Sphaerotheca macularis on hops, Sphaerotheca fusca (Sphaerotheca fuliginea) on cucurbits (for example cucumber), Leveillula taurica on tomatoes, aubergine and green pepper, Podosphaera leucotricha on apples and Uncinula necator on vines; Mycosphaerella graminicola (Septoria tritici) and Phaeosphaeria nodorum (Stagonospora nodorum or Septoria nodorum), Pseudocercosporella herpotrichoides and Gaeumannomyces graminis on cereals (for example wheat, barley, rye), turf and other hosts; Cercospora arachidicola and Cercosporidium personatum on peanuts and other Cercospora spp. on other hosts, for example sugar beet, bananas, soya beans and rice; Botrytis cinerea (grey mould) on tomatoes, strawberries, vegetables, vines and other hosts and other Botrytis spp. on other hosts; Alternaria spp. on vegetables (for example carrots), oil-seed rape, apples, tomatoes, potatoes, cereals (for example wheat) and other hosts; Venturia spp. (including Venturia inaequalis (scab)) on apples, pears, stone fruit, tree nuts and other hosts; Cladosporium spp. on a range of hosts including cereals (for example wheat) and tomatoes; Monilinia spp. on stone fruit, tree nuts and other hosts; Didymella spp. on tomatoes, turf, wheat, cucurbits and other hosts; Phoma spp. on oil-seed rape, turf, rice, potatoes, wheat and other hosts; Plasmopara viticola on vines; Plasmopara halstedii on sunflower; other downy mildews, such as Bremia lactucae on lettuce, Peronospora spp. on soybeans, tobacco, onions and other hosts, Pseudoperonospora humuli on hops; Peronosclerospora maydis, P. philippinensis and P. sorghi on maize, sorghum and other hosts and Pseudoperonospora cubensis on cucurbits; Pythium spp. (including Pythium ultimum) on cotton, maize, soybean, sugarbeet, vegetables, turf and other hosts; Phytophthora infestans on potatoes and tomatoes and other Phytophthora spp. on vegetables, strawberries, avocado, pepper, ornamentals, tobacco, cocoa and other hosts; Aphanomyces spp. on sugarbeet and other hosts; Thanatephorus cucumeris on rice, wheat, cotton, soybean, maize, sugarbeet and turf and other hosts Rhizoctonia spp. on various hosts such as wheat and barley, peanuts, vegetables, cotton and turf; Sclerotinia spp. on turf, peanuts, potatoes, oil-seed rape and other hosts; Sclerotium spp. on turf, peanuts and other hosts; Gibberella fujikuroi on rice; Colletotrichum spp. on a range of hosts including turf, coffee and vegetables; Laetisaria fuciformis on turf; Mycosphaerella spp. on bananas, peanuts, citrus, pecans, papaya and other hosts; Fusarium spp. incl. Fusarium culmorum, F. graminearum, F. langsethiae, F. moniliforme, F. proliferatum, F. subglutinans, F. solani and F. oxysporum on wheat, barely, rye, oats, maize, cotton, soybean, sugarbeet and other hosts; and Microdochium nivale.

A compound of formula (I) may move acropetally, basipetally or locally in plant tissue to be active against one or more fungi. Moreover, a compound of formula (I) may be volatile enough to be active in the vapour phase against one or more fungi on the plant.

The invention therefore provides a method of combating or controlling phytopathogenic fungi which comprises applying a fungicidally effective amount of a compound of formula (I), or a composition containing a compound of formula (I), to a plant, to a seed of a plant, to the locus of the plant or seed or to soil or any other plant growth medium, e.g. nutrient solution.

The term “plant” as used herein includes seedlings, bushes and trees. Furthermore, the fungicidal method of the invention includes protectant, curative, systemic, eradicant and antisporulant treatments.

The term “plant” as used herein also includes crops of useful plants in which the compositions according to the invention can be used and includes especially cereals, in particular wheat and barley, rice, corn, rape, sugarbeet, sugarcane, soybean, cotton, sunflower, peanut and plantation crops.

The term “crops” is to be understood as also including crops that have been rendered tolerant to herbicides or classes of herbicides (for example ALS, GS, EPSPS, PPO and HPPD inhibitors) as a result of conventional methods of breeding or genetic engineering.

The compounds of formula (I) are preferably used for agricultural, horticultural and turfgrass purposes in the form of a composition.

In order to apply a compound of formula (I) to a plant, to a seed of a plant, to the locus of the plant or seed or to soil or any other growth medium, a compound of formula (I) is usually formulated into a composition which includes, in addition to the compound of formula (I), a suitable inert diluent or carrier and, optionally, a surface active agent (SFA). SFAs are chemicals that are able to modify the properties of an interface (for example, liquid/solid, liquid/air or liquid/liquid interfaces) by lowering the interfacial tension and thereby leading to changes in other properties (for example dispersion, emulsification and wetting). It is preferred that all compositions (both solid and liquid formulations) comprise, by weight, 0.0001 to 95%, more preferably 1 to 85%, for example 5 to 60%, of a compound of formula (I). The composition is generally used for the control of fungi such that a compound of formula (I) is applied at a rate of from 0.1 g to 10 kg per hectare, preferably from 1 g to 6 kg per hectare, more preferably from 1 g to 1 kg per hectare.

When used in a seed dressing, a compound of formula (I) is used at a rate of 0.0001 g to 10 g (for example 0.001 g or 0.05 g), preferably 0.005 g to 10 g, more preferably 0.005 g to 4 g, per kilogram of seed.

In another aspect the present invention provides a fungicidal composition comprising a fungicidally effective amount of a compound of formula (I) and a suitable carrier or diluent therefor.

In a still further aspect the invention provides a method of combating and controlling fungi at a locus, which comprises treating the fungi, or the locus of the fungi with a fungicidally effective amount of a composition comprising a compound of formula (I). The compositions can be chosen from a number of formulation types, including dustable powders (DP), soluble powders (SP), water soluble granules (SG), water dispersible granules (WG), wettable powders (WP), granules (GR) (slow or fast release), soluble concentrates (SL), oil miscible liquids (OL), ultra low volume liquids (UL), emulsifiable concentrates (EC), dispersible concentrates (DC), emulsions (both oil in water (EW) and water in oil (EO)), micro-emulsions (ME), suspension concentrates (SC), aerosols, fogging/smoke formulations, capsule suspensions (CS) and seed treatment formulations. The formulation type chosen in any instance will depend upon the particular purpose envisaged and the physical, chemical and biological properties of the compound of formula (I).

Dustable powders (DP) may be prepared by mixing a compound of formula (I) with one or more solid diluents (for example natural clays, kaolin, pyrophyllite, bentonite, alumina, montmorillonite, kieselguhr, chalk, diatomaceous earths, calcium phosphates, calcium and magnesium carbonates, sulphur, lime, flours, talc and other organic and inorganic solid carriers) and mechanically grinding the mixture to a fine powder.

Soluble powders (SP) may be prepared by mixing a compound of formula (I) with one or more water-soluble inorganic salts (such as sodium bicarbonate, sodium carbonate or magnesium sulphate) or one or more water-soluble organic solids (such as a polysaccharide) and, optionally, one or more wetting agents, one or more dispersing agents or a mixture of said agents to improve water dispersibility/solubility. The mixture is then ground to a fine powder. Similar compositions may also be granulated to form water soluble granules (SG).

Wettable powders (WP) may be prepared by mixing a compound of formula (I) with one or more solid diluents or carriers, one or more wetting agents and, preferably, one or more dispersing agents and, optionally, one or more suspending agents to facilitate the dispersion in liquids. The mixture is then ground to a fine powder. Similar compositions may also be granulated to form water dispersible granules (WG).

Granules (GR) may be formed either by granulating a mixture of a compound of formula (I) and one or more powdered solid diluents or carriers, or from pre-formed blank granules by absorbing a compound of formula (I) (or a solution thereof, in a suitable agent) in a porous granular material (such as pumice, attapulgite clays, fuller's earth, kieselguhr, diatomaceous earths or ground corn cobs) or by adsorbing a compound of formula (I) (or a solution thereof, in a suitable agent) on to a hard core material (such as sands, silicates, mineral carbonates, sulphates or phosphates) and drying if necessary. Agents which are commonly used to aid absorption or adsorption include solvents (such as aliphatic and aromatic petroleum solvents, alcohols, ethers, ketones and esters) and sticking agents (such as polyvinyl acetates, polyvinyl alcohols, dextrins, sugars and vegetable oils). One or more other additives may also be included in granules (for example an emulsifying agent, wetting agent or dispersing agent).

Dispersible Concentrates (DC) may be prepared by dissolving a compound of formula (I) in water or an organic solvent, such as a ketone, alcohol or glycol ether. These solutions may contain a surface active agent (for example to improve water dilution or prevent crystallisation in a spray tank).

Emulsifiable concentrates (EC) or oil-in-water emulsions (EW) may be prepared by dissolving a compound of formula (I) in an organic solvent (optionally containing one or more wetting agents, one or more emulsifying agents or a mixture of said agents). Suitable organic solvents for use in ECs include aromatic hydrocarbons (such as alkylbenzenes or alkylnaphthalenes, exemplified by SOLVESSO 100, SOLVESSO 150 and SOLVESSO 200; SOLVESSO is a Registered Trade Mark), ketones (such as cyclohexanone or methylcyclohexanone), alcohols (such as benzyl alcohol, furfuryl alcohol or butanol), N-alkylpyrrolidones (such as N-methylpyrrolidone or N-octyl-pyrrolidone), dimethyl amides of fatty acids (such as C₈-C₁₀ fatty acid dimethylamide) and chlorinated hydrocarbons. An EC product may spontaneously emulsify on addition to water, to produce an emulsion with sufficient stability to allow spray application through appropriate equipment. Preparation of an EW involves obtaining a compound of formula (I) either as a liquid (if it is not a liquid at ambient temperature, it may be melted at a reasonable temperature, typically below 70° C.) or in solution (by dissolving it in an appropriate solvent) and then emulsifying the resultant liquid or solution into water containing one or more SFAs, under high shear, to produce an emulsion. Suitable solvents for use in EWs include vegetable oils, chlorinated hydrocarbons (such as chlorobenzenes), aromatic solvents (such as alkylbenzenes or alkylnaphthalenes) and other appropriate organic solvents that have a low solubility in water.

Microemulsions (ME) may be prepared by mixing water with a blend of one or more solvents with one or more SFAs, to produce spontaneously a thermodynamically stable isotropic liquid formulation. A compound of formula (I) is present initially in either the water or the solvent/SFA blend. Suitable solvents for use in MEs include those hereinbefore described for use in ECs or in EWs. An ME may be either an oil-in-water or a water-in-oil system (which system is present may be determined by conductivity measurements) and may be suitable for mixing water-soluble and oil-soluble pesticides in the same formulation. An ME is suitable for dilution into water, either remaining as a microemulsion or forming a conventional oil-in-water emulsion.

Suspension concentrates (SC) may comprise aqueous or non-aqueous suspensions of finely divided insoluble solid particles of a compound of formula (I). SCs may be prepared by ball or bead milling the solid compound of formula (I) in a suitable medium, optionally with one or more dispersing agents, to produce a fine particle suspension of the compound. One or more wetting agents may be included in the composition and a suspending agent may be included to reduce the rate at which the particles settle. Alternatively, a compound of formula (I) may be dry milled and added to water, containing agents hereinbefore described, to produce the desired end product.

Aerosol formulations comprise a compound of formula (I) and a suitable propellant (for example N-butane). A compound of formula (I) may also be dissolved or dispersed in a suitable medium (for example water or a water miscible liquid, such as N-propanol) to provide compositions for use in non-pressurised, hand-actuated spray pumps.

A compound of formula (I) may be mixed in the dry state with a pyrotechnic mixture to form a composition suitable for generating, in an enclosed space, a smoke containing the compound.

Capsule suspensions (CS) may be prepared in a manner similar to the preparation of EW formulations but with an additional polymerisation stage such that an aqueous dispersion of oil droplets is obtained, in which each oil droplet is encapsulated by a polymeric shell and contains a compound of formula (I) and, optionally, a carrier or diluent therefor. The polymeric shell may be produced by either an interfacial polycondensation reaction or by a coacervation procedure. The compositions may provide for controlled release of the compound of formula (I) and they may be used for seed treatment. A compound of formula (I) may also be formulated in a biodegradable polymeric matrix to provide a slow, controlled release of the compound.

A composition may include one or more additives to improve the biological performance of the composition (for example by improving wetting, retention or distribution on surfaces; resistance to rain on treated surfaces; or uptake or mobility of a compound of formula (I)). Such additives include surface active agents, spray additives based on oils, for example certain mineral oils or natural plant oils (such as soy bean and rape seed oil), and blends of these with other bio-enhancing adjuvants (ingredients which may aid or modify the action of a compound of formula (I)).

A compound of formula (I) may also be formulated for use as a seed treatment, for example as a powder composition, including a powder for dry seed treatment (DS), a water soluble powder (SS) or a water dispersible powder for slurry treatment (WS), or as a liquid composition, including a flowable concentrate (FS), a solution (LS) or a capsule suspension (CS). The preparations of DS, SS, WS, FS and LS compositions are very similar to those of, respectively, DP, SP, WP, SC and DC compositions described above. Compositions for treating seed may include an agent for assisting the adhesion of the composition to the seed (for example a mineral oil or a film-forming barrier). Wetting agents, dispersing agents and emulsifying agents may be SFAs of the cationic, anionic, amphoteric or non-ionic type.

Suitable SFAs of the cationic type include quaternary ammonium compounds (for example cetyltrimethyl ammonium bromide), imidazolines and amine salts. Suitable anionic SFAs include alkali metals salts of fatty acids, salts of aliphatic monoesters of sulphuric acid (for example sodium lauryl sulphate), salts of sulphonated aromatic compounds (for example sodium dodecylbenzenesulphonate, calcium dodecylbenzenesulphonate, butylnaphthalene sulphonate and mixtures of sodium di-isopropyl- and tri-isopropyl-naphthalene sulphonates), ether sulphates, alcohol ether sulphates (for example sodium laureth-3-sulphate), ether carboxylates (for example sodium laureth-3-carboxylate), phosphate esters (products from the reaction between one or more fatty alcohols and phosphoric acid (predominately mono-esters) or phosphorus pentoxide (predominately di-esters), for example the reaction between lauryl alcohol and tetraphosphoric acid; additionally these products may be ethoxylated), sulphosuccinamates, paraffin or olefin sulphonates, taurates and lignosulphonates. Suitable SFAs of the amphoteric type include betaines, propionates and glycinates. Suitable SFAs of the non-ionic type include condensation products of alkylene oxides, such as ethylene oxide, propylene oxide, butylene oxide or mixtures thereof, with fatty alcohols (such as oleyl alcohol or cetyl alcohol) or with alkylphenols (such as octylphenol, nonylphenol or octylcresol); partial esters derived from long chain fatty acids or hexitol anhydrides; condensation products of said partial esters with ethylene oxide; block polymers (comprising ethylene oxide and propylene oxide); alkanolamides; simple esters (for example fatty acid polyethylene glycol esters); amine oxides (for example lauryl dimethyl amine oxide); and lecithins.

Suitable suspending agents include hydrophilic colloids (such as polysaccharides, polyvinylpyrrolidone or sodium carboxymethylcellulose) and swelling clays (such as bentonite or attapulgite).

A compound of formula (I) may be applied by any of the known means of applying fungicidal compounds. For example, it may be applied, formulated or unformulated, to any part of the plant, including the foliage, stems, branches or roots, to the seed before it is planted or to other media in which plants are growing or are to be planted (such as soil surrounding the roots, the soil generally, paddy water or hydroponic culture systems), directly or it may be sprayed on, dusted on, applied by dipping, applied as a cream or paste formulation, applied as a vapour or applied through distribution or incorporation of a composition (such as a granular composition or a composition packed in a water-soluble bag) in soil or an aqueous environment.

A compound of formula (I) may also be injected into plants or sprayed onto vegetation using electrodynamic spraying techniques or other low volume methods, or applied by land or aerial irrigation systems.

Compositions for use as aqueous preparations (aqueous solutions or dispersions) are generally supplied in the form of a concentrate containing a high proportion of the active ingredient, the concentrate being added to water before use. These concentrates, which may include DCs, SCs, ECs, EWs, MEs, SGs, SPs, WPs, WGs and CSs, are often required to withstand storage for prolonged periods and, after such storage, to be capable of addition to water to form aqueous preparations which remain homogeneous for a sufficient time to enable them to be applied by conventional spray equipment. Such aqueous preparations may contain varying amounts of a compound of formula (I) (for example 0.0001 to 10%, by weight) depending upon the purpose for which they are to be used.

A compound of formula (I) may be used in mixtures with fertilisers (for example nitrogen-, potassium- or phosphorus-containing fertilisers). Suitable formulation types include granules of fertiliser. The mixtures suitably contain up to 25% by weight of the compound of formula (I).

The invention therefore also provides a fertiliser composition comprising a fertiliser and a compound of formula (I).

The compositions of this invention may contain other compounds having biological activity, for example micronutrients or compounds having similar or complementary fungicidal activity or which possess plant growth regulating, herbicidal, insecticidal, nematicidal or acaricidal activity.

By including another fungicide, the resulting composition may have a broader spectrum of activity or a greater level of intrinsic activity than the compound of formula (I) alone. Further, the other fungicide may have a synergistic effect on the fungicidal activity of the compound of formula (I).

The compound of formula (I) may be the sole active ingredient of the composition or it may be admixed with one or more additional active ingredients such as a pesticide, fungicide, synergist, herbicide or plant growth regulator where appropriate. An additional active ingredient may: provide a composition having a broader spectrum of activity or increased persistence at a locus; synergise the activity or complement the activity (for example by increasing the speed of effect or overcoming repellency) of the compound of formula (I); or help to overcome or prevent the development of resistance to individual components. The particular additional active ingredient will depend upon the intended utility of the composition.

Examples of further fungicidal compounds which may be included in the composition of the invention are AC 382042 (N-(1-cyano-1,2-dimethylpropyl)-2-(2,4-dichlorophenoxy)propionamide), acibenzolar-5-methyl, alanycarb, aldimorph, anilazine, azaconazole, azafenidin, azoxystrobin, benalaxyl, benomyl, benthiavalicarb, biloxazol, bitertanol, blasticidin S, boscalid (new name for nicobifen), bromuconazole, bupirimate, captafol, captan, carbendazim, carbendazim chlorhydrate, carboxin, carpropamid, carvone, CGA 41396, CGA 41397, chinomethionate, chlorbenzthiazone, chlorothalonil, chlorozolinate, clozylacon, copper containing compounds such as copper oxychloride, copper oxyquinolate, copper sulphate, copper tallate, and Bordeaux mixture, cyamidazosulfamid, cyazofamid (IKF-916), cyflufenamid, cymoxanil, cyproconazole, cyprodinil, debacarb, di-2-pyridyl disulphide 1,1′-dioxide, dichlofluanid, diclocymet, diclomezine, dicloran, diethofencarb, difenoconazole, difenzoquat, diflumetorim, O,O-di-iso-propyl-5-benzyl thiophosphate, dimefluazole, dimetconazole, dimethirimol, dimethomorph, dimoxystrobin, diniconazole, dinocap, dithianon, dodecyl dimethyl ammonium chloride, dodemorph, dodine, doguadine, edifenphos, epoxiconazole, ethaboxam, ethirimol, ethyl (Z)—N-benzyl-N([methyl(methyl-thioethylideneaminooxy-carbonyl)amino]thio)-β-alaninate, etridiazole, famoxadone, fenamidone, fenarimol, fenbuconazole, fenfuram, fenhexamid, fenoxanil (AC 382042), fenpiclonil, fenpropidin, fenpropimorph, fentin acetate, fentin hydroxide, ferbam, ferimzone, fluazinam, fludioxonil, flumetover, flumorph, fluoroimide, fluoxastrobin, fluquinconazole, flusilazole, flusulfamide, flutolanil, flutriafol, folpet, fosetyl-aluminium, fuberidazole, furalaxyl, furametpyr, guazatine, hexaconazole, hydroxyisoxazole, hymexazole, imazalil, imibenconazole, iminoctadine, iminoctadine triacetate, ipconazole, iprobenfos, iprodione, iprovalicarb, isopropanyl butyl carbamate, isoprothiolane, kasugamycin, kresoxim-methyl, LY186054, LY211795, LY 248908, mancozeb, maneb, mefenoxam, mepanipyrim, mepronil, metalaxyl, metalaxyl M, metconazole, metiram, metiram-zinc, metominostrobin, metrafenone, MON65500 (N-allyl-4,5-dimethyl-2-trimethylsilylthiophene-3-carboxamide), myclobutanil, NTN0301, neoasozin, nickel dimethyldithiocarbamate, nitrothale-isopropyl, nuarimol, ofurace, organomercury compounds, orysastrobin, oxadixyl, oxasulfuron, oxolinic acid, oxpoconazole, oxycarboxin, pefurazoate, penconazole, pencycuron, phenazin oxide, phosphorus acids, phthalide, picoxystrobin, polyoxin D, polyram, probenazole, prochloraz, procymidone, propamocarb, propamocarb hydrochloride, propiconazole, propineb, propionic acid, proquinazid, prothioconazole, pyraclostrobin, pyrazophos, pyrifenox, pyrimethanil, pyroquilon, pyroxyfur, pyrroInitrin, quaternary ammonium compounds, quinomethionate, quinoxyfen, quintozene, silthiofam (MON 65500), S-imazalil, simeconazole, sipconazole, sodium pentachlorophenate, spiroxamine, streptomycin, sulphur, tebuconazole, tecloftalam, tecnazene, tetraconazole, thiabendazole, thifluzamide, 2-(thiocyano-methylthio)benzothiazole, thiophanate-methyl, thiram, tiadinil, timibenconazole, tolclofos-methyl, tolylfluanid, triadimefon, triadimenol, triazbutil, triazoxide, tricyclazole, tridemorph, trifloxystrobin, triflumizole, triforine, triticonazole, validamycin A, vapam, vinclozolin, XRD-563, zineb, ziram, zoxamide and the compounds of the formulae:

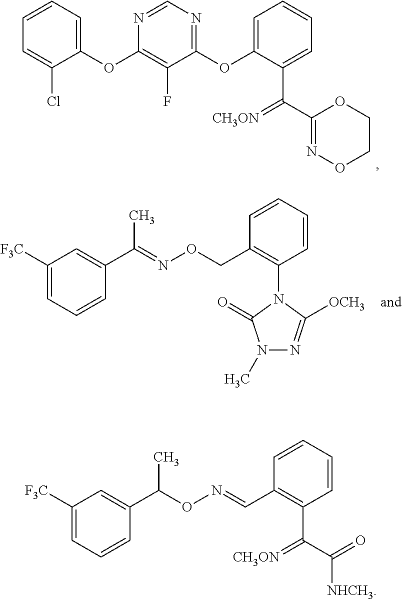

The compounds of formula (I) may be mixed with soil, peat or other rooting media for the protection of plants against seed-borne, soil-borne or foliar fungal diseases. Some mixtures may comprise active ingredients, which have significantly different physical, chemical or biological properties such that they do not easily lend themselves to the same conventional formulation type. In these circumstances other formulation types may be prepared. For example, where one active ingredient is a water insoluble solid and the other a water insoluble liquid, it may nevertheless be possible to disperse each active ingredient in the same continuous aqueous phase by dispersing the solid active ingredient as a suspension (using a preparation analogous to that of an SC) but dispersing the liquid active ingredient as an emulsion (using a preparation analogous to that of an EW). The resultant composition is a suspoemulsion (SE) formulation.

The invention is illustrated by the following Examples in which the following abbreviations are used:

| | |
|---|---|
| mL = millilitres | DMF = dimethylformamide |
| g = grammes | NMR = nuclear magnetic resonance |
| ppm = parts per million | HPLC = high performance liquid |
| M⁺ = mass ion | chromatography |
| s = singlet | q = quartet |
| d = doublet | m = multiplet |
| br s = broad singlet | ppm = parts per million |
| t = triplet | HOAT = 1-Hydroxy-7- |
| EDCI = 1-Ethyl-3-(3- | azabenzotriazole |
| dimethylaminopropyl)carbodiimide | EtOAc = Ethyl acetate |
| NCS = N-chlorosuccinimide | TFA = trifluoroacetic acid |
| M.P. = melting point in ° C. | NBS = N-bromosuccinimide |
| HPLC = High-Pressure Liquid | THF = tetrahydrofuran |
| Chromatography | UPLC = Ultra-high Pressur Liquid |
| | Chromatography |

LC-MS means Liquid Chromatography Mass Spectroscopy and the description of the apparatus and the methods used are as follows:

LC1:

| MS | ZQ Mass Spectrometer from Waters (single quadrupole mass spectrometer), ionization | | | |
|---|---|---|---|---|
| | method: electrospray, polarity: positive ionization, capillary (kV) 3.00, cone (V) 30.00, | | | |
| | Extractor (V) 3.00, source temperature (° C.) 100, desolvation temperature (° C.) 250, | | | |
| | cone gas flow (L/Hr) 50, desolvation gas flow (L/Hr) 400, mass range: 150 to 1000 Da. | | | |
| LC | HPLC HP1100 from Agilent: quaternary pump, heated column compartment and diode- | | | |
| | array detector. | | | |
| | Column Phenomenex Gemini C18; length: 20 mm; internal diameter: 3 mm; particle | | | |
| | size: 3 μm, temperature 60° C., DAD wavelength range (nm): 200 to 500, solvent | | | |
| | gradient: A = 0.04% of formic acid in water and B = acetonitrile/methanol (4:1 v/v) + | | | |
| | 0.05% of formic acid in acetonitrile. | | | |
| | Time (min) | A % | B % | Flow (mL/min) |
| | 0.0 | 80 | 20 | 1.7 |
| | 2.5 | 0.0 | 100 | 1.7 |
| | 2.8 | 0.0 | 100 | 1.7 |
| | 2.9 | 80 | 20 | 1.7 |

LC2:

| MS | ZMD Mass Spectrometer from Waters (single quadrupole mass spectrometer), | | | |
|---|---|---|---|---|
| | ionization method: electrospray, polarity: positive ionization, capillary (kV) | | | |
| | 3.00, cone (V) 30.00, Extractor (V) 3.00, source temperature (° C.) 150, | | | |
| | desolvation temperature (° C.) 320, cone gas flow (L/Hr) 50, desolvation gas | | | |
| | flow (L/Hr) 400, mass range: 150 to 800 Da. | | | |
| LC | Alliance 2795 LC HPLC from Waters: quaternary pump, heated column | | | |
| | compartment and diode-array detector. | | | |
| | Column: Waters Atlantis dc18; length: 20 mm; internal diameter: 3 mm; | | | |
| | particle size: 3 μm, temperature (° C.) 40, DAD wavelength range (nm): 200 to | | | |
| | 500, solvent gradient: A = 0.1% formic acid in water and B = 0.1% | | | |
| | formic acid in acetonitrile. | | | |
| | Time (min) | A % | B % | Flow (mL/min) |
| | 0.0 | 80 | 20 | 1.7 |
| | 2.5 | 0.0 | 100 | 1.7 |
| | 2.8 | 0.0 | 100 | 1.7 |
| | 2.9 | 80 | 20 | 1.7 |

LC3-Short:

| MS | ZQ Mass Spectrometer from Waters (single quadrupole mass spectrometer), | | | |
|---|---|---|---|---|
| | ionization method: electrospray, polarity: positive ionization, capillary (kV) | | | |
| | 3.00, cone (V) 30.00, extractor (V) 3.00, source temperature (° C.) 100, | | | |
| | desolvation temperature (° C.) 200, cone gas flow (L/Hr) 200, desolvation gas | | | |
| | flow (L/Hr) 250, mass range: 150 to 800 Da. | | | |
| LC | 1100er Series HPLC from Agilent: quaternary pump, heated column | | | |
| | compartment and diode-array detector. | | | |
| | Column: Waters Atlantis dc18; length: 20 mm; internal diameter: 3 mm; | | | |
| | particle size: 3 μm, temperature (° C.) 40, DAD wavelength range (nm): 200 to | | | |
| | 500, solvent gradient: A = 0.1% formic acid in water and B = 0.1% | | | |
| | formic acid in acetonitrile. | | | |
| | Time (min) | A % | B % | Flow (mL/min) |
| | 0.0 | 80 | 20 | 1.7 |
| | 2.5 | 0.0 | 100 | 1.7 |
| | 2.8 | 0.0 | 100 | 1.7 |
| | 2.9 | 80 | 20 | 1.7 |

LC3-Long:

This method is identical to method LC3-short except that the gradient is as follows:

| Time (min.) | A (%) | B (%) | Flow (mL/min) |
|---|---|---|---|
| 0 | 90 | 10 | 1.7 |
| 5.5 | 0 | 100 | 1.7 |
| 5.8 | 0 | 100 | 1.7 |
| 5.9 | 90 | 10 | 1.7 |

UPLC:

| MS | ACQUITY SQD Mass Spectrometer from Waters (single quadrupole mass | | | |
|---|---|---|---|---|
| | spectrometer), ionization method: electrospray, polarity: positive ionization, | | | |
| | capillary (kV) 3.00, cone (V) 20.00, extractor (V) 3.00, source temperature (° C.) | | | |
| | 150, desolvation temperature (° C.) 400, cone gas flow (L/Hr) 60, desolvation gas | | | |
| | flow (L/Hr) 700, mass range: 100 to 800 Da. | | | |
| LC | ACQUITY UPLC from Waters: quaternary pump, heated column compartment | | | |
| | and diode-array detector. | | | |
| | Column:: Waters ACQUITY UPLC dc18; length: 30 mm; internal diameter: 2.1 | | | |
| | mm; particle size: 1.8 μm, temperature (° C.) 60, DAD wavelength range | | | |
| | (nm): 210 to 400, solvent gradient: A = 0.1% of formic acid in water and | | | |
| | B: 0.1% of formic acid in acetonitrile. | | | |
| | Time (minutes) | A (%) | B (%) | Flow rate (ml/min) |
| | 0 | 100 | 0 | 0.75 |
| | 2.5 | 0 | 100 | 0.75 |
| | 2.8 | 0 | 100 | 0.75 |
| | 3 | 100 | 0 | 0.75 |

The 2-[(3-ethynyl-6-quinolyl)oxy]-2-methylsulfanyl-acetic acid, the 2-[(3-ethynyl-8-methyl-6-quinolyl)oxy]-2-methylsulfanyl-acetic acid and the methyl 2-methylsulfanyl-2-[[3-(2-trimethylsilylethynyl)-6-quinolyl]oxy]acetate were obtained following published procedures, for example those mentioned in WO 09/030,467.

### EXAMPLE 1

This examples illustrates the preparation of methyl methyl (1Z)-2-[[2-[(3-ethynyl-6-quinolyl)oxy]-2-methylsulfanyl-acetyl]amino]-N-isopropenyl-2-methyl-propanimidothioate (Compound No. 28 of Table 49) which was prepared according to the Sequence 1 depicted below.

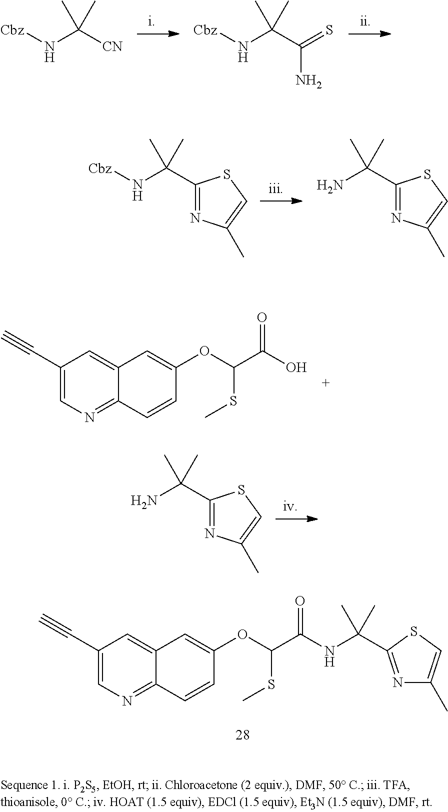

### Step 1: benzyl N-(2-amino-1,1-dimethyl-2-thioxo-ethyl)carbamate

To EtOH (500 mL) at RT was added solid P₂S₅ (293 mmol, 65.2 g) over 15 min during which time an exotherm was observed (40° C.) and gas evolved and the initial suspension gradually became a clear solution over an hour. After which time benzyl N-(1-cyano-1-methyl-ethyl)carbamate (147 mmol, 32.0 g) was added and the reaction was stirred overnight a RT. The reaction mixture was then extracted with EtOAc, washed with water and dried over Na₂SO₄. The crude product was purified by column chromatography (EtOAc/Heptane 1:2) to yield benzyl N-(2-amino-1,1-dimethyl-2-thioxo-ethyl)carbamate as off-white crystals.

LC1: rt=1.49 min, m/z=253 ([MH]⁺)

### Step 2: Preparation of benzyl N-[1-methyl-1-(4-methylthiazol-2-yl)ethyl]carbamate

To a solution of benzyl N-(2-amino-1,1-dimethyl-2-thioxo-ethyl)carbamate (2.9 mmol, 580 mg) in DMF (5 mL) at RT was added chloroacetone (4.7 mmol, 430 mg) and the reaction was heated to 50° C. and stirred overnight. The reaction was cooled and taken up in EtOAc and the organic phase was washed with water, brine and dried over Na₂SO₄ filtered and evaporated. The crude product was purified by column chromatography (EtOAc/Heptane 1:3) to yield benzyl N-[1-methyl-1-(4-methylthiazol-2-yl)ethyl]carbamate as a yellow oil. LC1: rt=1.71 min, m/z=291 ([MH]⁺)

### Step 3: 2-(4-methylthiazol-2-yl)propan-2-amine

To a solution of benzyl N-[1-methyl-1-(4-methylthiazol-2-yl)ethyl]carbamate (3.5 mmol, 1.0 g) in thioanisole cooled to 0° C. was added TFA (10 mL) and the reaction was stirred for 15 min before being brought back to RT and stirred overnight. The reaction mixture was then extracted with EtOAc and the organic phase was washed sequentially with an aqueous K₂CO₃ solution, brine, dried over MgSO₄, filtered and evaporated. The crude product was purified by column chromatography (Hept.→EtOAc) to yield 2-(4-methylthiazol-2-yl)propan-2-amine as a yellow oil.

¹H NMR (CDCl₃) δ ppm: 6.71 (1H, s), 2.40 (3H, s), 2.15 (1H, bs), 1.56 (6H, s).

### Step 4: yield methyl (1Z)-2-[[2-[(3-ethynyl-6-quinolyl)oxy]-2-methylsulfanyl-acetyl]amino]-N-isopropenyl-2-methyl-propanimidothioate (Compound No. 28 Table 49)

To solution of 2-[(3-ethynyl-6-quinolyl)oxy]-2-methylsulfanyl-acetic acid (1 mmol, 342 mg) in DMF (6 mL) was sequentially Et₃N (1.56 mmol, 0.217 mL), HOAT (1.56 mmol, 213 mg), 2-(4-methylthiazol-2-yl)propan-2-amine (1.56 mmol, 244 mg) and EDCI (1.56 mmol, 300 mg). The reaction was then stirred for 16 h at RT. The reaction mixture was taken up in EtOAc and washed three times with brine, dried over MgSO₄, filtered and evaporated. The crude product was purified by column chromatography over SiO₂ (EtOAc/Heptane 1:1) to yield methyl (1Z)-2-[[2-[(3-ethynyl-6-quinolyl)oxy]-2-methylsulfanyl-acetyl]amino]-N-isopropenyl-2-methyl-propanimidothioate as an off-white solid.

LC1: rt=1.76 min, m/z=412 ([MH]⁺), Mp=97-99° C.; ¹H NMR (CDCl₃) δ ppm: 8.83 (1H, d), 8.21 (1H, s), 8.09 (1H, s), 8.05 (1H, s), 7.52 (1H, dd), 7.25 (1H, d), 7.25 (1H, d), 6.82 (1H, s), 5.68 (1H, s), 3.29 (1H, s), 2.45 (3H, s), 2.23 (3H, s), 1.92 (3H, s), 1.87 (3H, s).

### EXAMPLE 2

This examples illustrates the preparation of methyl 3-[1-[[2-[(3-ethynyl-6-quinolyl)oxy]-2-methylsulfanyl-acetyl]amino]-1-methyl-ethyl]isothiazole-5-carboxylate (Compound No. 62 of Table 50) which was prepared according to the Sequence 2 depicted below.

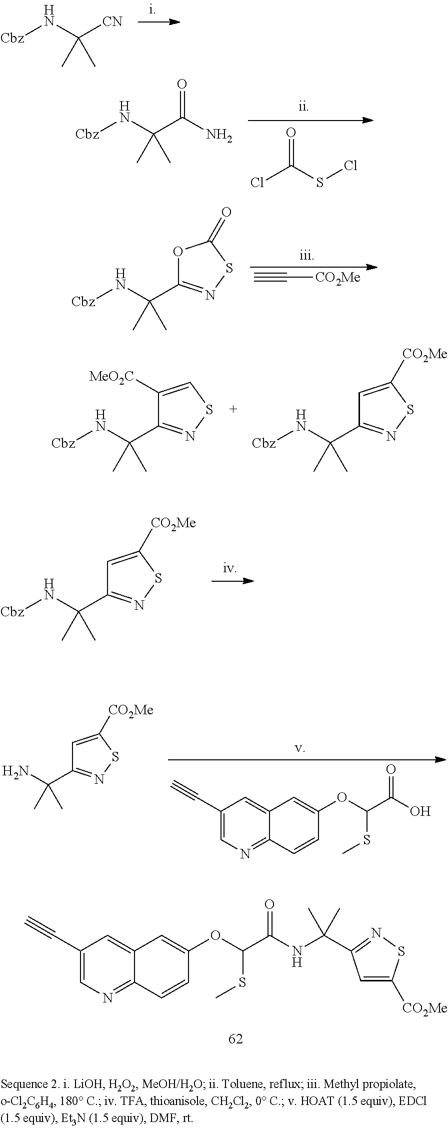

### Step 1: Preparation of benzyl N-(2-amino-1,1-dimethyl-2-oxo-ethyl)carbamate

To a solution of benzyl N-(1-cyano-1-methyl-ethyl)carbamate (4.6 mmol, 1.0 g) in MeOH (40 mL) was added H₂O₂ (35% in H₂O, 3 mL), followed by LiOH.H₂O (9.2 mmol, 380 mg). After 30 min at RT the reaction was cooled to 0° C. and a solution of Na₂SO₃/citric acid (1:1, 10% wv) was added slowly until the exotherm ceased. The reaction mixture was taken up in EtOAc and washed three times with brine, dried over Na₂SO₄, filtered and evaporated to yield benzyl N-(2-amino-1,1-dimethyl-2-oxo-ethyl)carbamate as white crystals.

¹H NMR (CDCl₃) δ ppm: 7.35-740 (5H, m), 6.31 (1H, bs), 5.78 (1H, bs), 5.53 (1H, bs), 5.08 (2H, s), 1.56 (6H, s).

### Step 2: Preparation of benzyl N-[1-methyl-1-(2-oxo-1,3,4-oxathiazol-5-yl)ethyl]carbamate

To a solution of benzyl N-(2-amino-1,1-dimethyl-2-oxo-ethyl)carbamate (5.93 mmol, 1.40 g) in toluene (23 mL) was added chlorocarbonylsulfenchloride (11.86 mmol, 1.60 g) and the solution was refluxed for 1 h. The solvents were removed and the crude product was purified by column chromatography over SiO₂ (EtOAc/Heptane 1:4) to yield benzyl N-[1-methyl-1-(2-oxo-1,3,4-oxathiazol-5-yl)ethyl]carbamate as an oil.

¹H NMR (CDCl₃) δ ppm: 7.35-740 (5H, m), 5.24 (1H, bs), 5.07 (2H, s), 1.62 (6H, s).

### Step 3: Preparation of methyl 3-[1-(benzyloxycarbonylamino)-1-methyl-ethyl]isothiazole-4-carboxylate and methyl 3-[1-(benzyloxycarbonylamino)-1-methyl-ethyl]isothiazole-5-carboxylate

To a solution of benzyl N-[1-methyl-1-(2-oxo-1,3,4-oxathiazol-5-yl)ethyl]carbamate (1.15 mmol, 340 mg) dissolved in o-dichlorobenzene (3 mL) in a sealed tube and was added methyl propiolate (6.82 mmol, 1 mL). The reaction was heated at a 180° C. for 30 min. The crude mixture was purified by column chromatography over SiO₂ (EtOAc/Heptane 1:4) to yield pure methyl 3-[1-(benzyloxycarbonylamino)-1-methyl-ethyl]isothiazole-4-carboxylate and methyl 3-[1-(benzyloxycarbonylamino)-1-methyl-ethyl]isothiazole-5-carboxylate.

Methyl 3-[1-(benzyloxycarbonylamino)-1-methyl-ethyl]isothiazole-4-carboxylate: ¹H NMR (CDCl₃) δ ppm: 9.18 (1H, s), 7.21-7.31 (5H, m), 6.07 (1H, bs), 4.98 (2H, s), 3.76 (3H, s) 1.81 (6H, s).

Methyl 3-[1-(benzyloxycarbonylamino)-1-methyl-ethyl]isothiazole-5-carboxylate: ¹H NMR (CDCl₃) δ ppm: 7.71 (1H, s), 7.29-7.39 (5H, m), 5.89 (1H, bs), 5.03 (2H, s), 3.92 (3H, s) 1.73 (6H, s).

### Step 4: Preparation of methyl 3-(1-amino-1-methyl-ethyl)isothiazole-5-carboxylate

To a solution of Methyl 3-[1-(benzyloxycarbonylamino)-1-methyl-ethyl]isothiazole-5-carboxylate (0.82 mmol, 0.49 g) in CH₂Cl₂ (15 mL) and thioanisole (1 mL) cooled to 0° C. was added TFA (3 mL) and the reaction was stirred for 30 min before being brought back to RT and stirred overnight. The reaction mixture was then extracted with CH₂Cl₂ and the organic phase was washed sequentially with an aqueous K₂CO₃ solution, brine, dried over Na₂SO₄, filtered and evaporated. The crude product was purified by column chromatography (Hept/EtOAc 3:1) to yield methyl 3-(1-amino-1-methyl-ethyl)isothiazole-5-carboxylate as a yellow oil.

¹H NMR (CDCl₃) δ ppm: 9.21 (1H, s), 3.83 (3H, s), 2.22 (2H, bs) 1.57 (6H, s).

### Step 5: Preparation of methyl 3-[1-[[2-[(3-ethynyl-6-quinolyl)oxy]-2-methylsulfanyl-acetyl]amino]-1-methyl-ethyl]isothiazole-5-carboxylate (Compound No. 62 of Table 50)

To solution of 2-[(3-ethynyl-6-quinolyl)oxy]-2-methylsulfanyl-acetic acid (0.36 mmol, 99 mg) in DMF (2 mL) was sequentially added Et₃N (0.45 mmol, 0.063 mL), HOAT (0.45 mmol, 62 mg), methyl 3-(1-amino-1-methyl-ethyl)isothiazole-5-carboxylate (0.45 mmol, 75 mg) and EDCI (0.45 mmol, 87 mg). The reaction was then stirred for 16 h at RT. The reaction mixture was taken up in EtOAc and washed three times with brine, dried over MgSO₄, filtered and evaporated. The crude product was purified by column chromatography over SiO₂ (EtOAc/Heptane 1:1) to yield methyl 3-[1-[[2-[(3-ethynyl-6-quinolyl)oxy]-2-methylsulfanyl-acetyl]amino]-1-methyl-ethyl]isothiazole-5-carboxylate as an off-white solid.

LC1: rt=1.81 min, m/z=456 ([MH]⁺); ¹H NMR (CDCl₃) δ ppm: 9.28 (1H, s), 8.87 (1H, s), 8.19 (1H, s), 8.09 (1H, d), 8.08 (1H, s), 7.58 (1H, dd), 7.22 (1H, d), 5.55 (1H, s), 3.70 (3H, s), 3.32 (1H, s), 2.21 (3H, s), 1.98 (3H, s), 1.92 (3H, s).

### EXAMPLE 3

This example illustrates the preparation of 2-[(3-ethynyl-8-methyl-6-quinolyl)oxy]-N-(1-isoxazol-3-yl-1-methyl-ethyl)-2-methylsulfanyl-acetamide (compound No. 39 Table 50) according to the Sequence 3 depicted below.

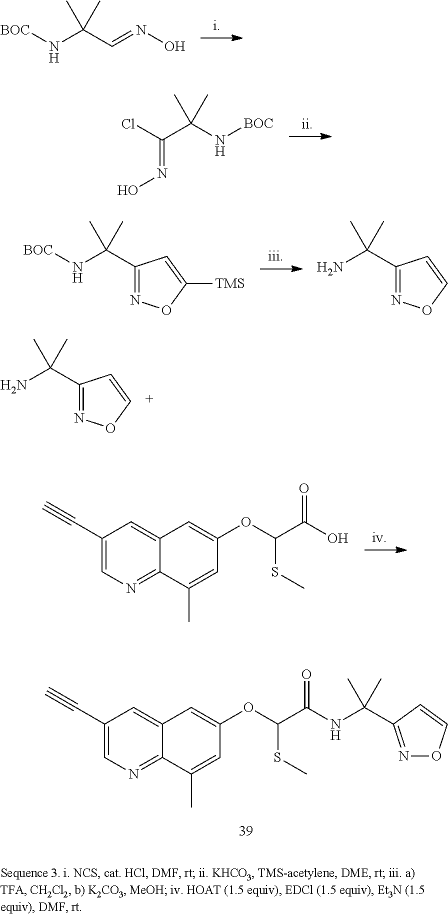

### Step 1: Preparation of tert-butyl N-[(2Z)-2-chloro-2-hydroxyimino-1,1-dimethyl-ethyl]carbamate

To a solution of tert-butyl N-[(2E)-2-hydroxyimino-1,1-dimethyl-ethyl]carbamate (247.2 mmol, 50 g) in DMF (247 mL) at RT was added HCl (2 M in Et₂O, 17.8 mmol, 8.90 mL) followed by portion-wise addition of NCS (271.9 mmol, 36.3 g) over 15 min. The reaction was stirred an additional 3 h. The mixture was taken up in EtOAc and washed five times with brine, dried over MgSO₄, filtered and evaporated to yield tert-butyl N-[(2Z)-2-chloro-2-hydroxyimino-1,1-dimethyl-ethyl]carbamate as a pugent white solid.

¹H NMR (CDCl₃) δ ppm: 8.62 (1H, bs), 4.93 (1H, bs), 1.56 (6H, s), 1.41 (9H, s).

### Step 2: Preparation of tert-butyl N-[1-methyl-1-(5-trimethylsilylisoxazol-3-yl)ethyl]carbamate

To a mechanically stirred solution of tert-butyl N-[(2Z)-2-chloro-2-hydroxyimino-1,1-dimethyl-ethyl]carbamate (430 mmol, 102 g) in DME (215 mL) at RT was added trimethylsilylacetylene (861.8 mmol, 122.6 mL) followed by KHCO₃ (861.8 mmol, 86.3 g). The mixture was stirred at RT for 16 h. The reaction was then taken up in EtOAc and washed sequentially with water, brine, dried over MgSO₄, filtered and evaporated to yield tert-butyl N-[1-methyl-1-(5-trimethylsilylisoxazol-3-yl)ethyl]carbamate as a white microcrystalline powder.

¹H NMR (CDCl₃) δ ppm: 6.39 (1H, s), 5.19 (1H, bs), 1.68 (6H, bs), 1.39 (9H, bs), 0.32 (9H, bs).

### Step 3: 2-isoxazol-3-ylpropan-2-amine

To a solution of tert-butyl N-[1-methyl-1-(5-trimethylsilylisoxazol-3-yl)ethyl]carbamate (1.5 mmol, 449 mg) in CH₂Cl₂ (3 mL) at 0° C. was added TFA (1 mL) and the reaction was stirred at 0° C. for 15 min before being brought back to RT for 3 h. The mixture was evaporated to dryness and redissolved in MeOH (10 mL) and K₂CO₃ (2 g) was added and the reaction was stirred for 1 h at RT. Water (30 mL) was added to the reaction and the resulting mixture was extract three time with EtOAc. The combined organic phases were dried over MgSO₄, filtered and evaporated to yield 2-isoxazol-3-ylpropan-2-amine as a light yellow oil.

¹H NMR (CDCl₃) δ ppm: 8.30 (1H, d), 6.29 (1H, d), 2.28 (2H, bs), 1.51 (6H, s).

### Step 4: Preparation of 2-[(3-ethynyl-8-methyl-6-quinolyl)oxy]-N-(1-isoxazol-3-yl-1-methyl-ethyl)-2-methylsulfanyl-acetamide (compound No. 39 Table 50)

To a solution of 2-[(3-ethynyl-8-methyl-6-quinolyl)oxy]-2-methylsulfanyl-acetic acid (0.86 mmol, 248 mg) in DMF (4 mL) was sequentially added Et₃N (1.08 mmol, 0.150 mL), HOAT (1.08 mmol, 147 mg), 2-isoxazol-3-ylpropan-2-amine (1.08 mmol, 136 mg) and EDCI (1.08 mmol, 207 mg). The reaction was then stirred for 16 h at RT. The reaction mixture was taken up in EtOAc and washed three times with brine, dried over MgSO4, filtered and evaporated. The crude product was purified by column chromatography over SiO₂ (EtOAc/Heptane 1:1) to yield 2-[(3-ethynyl-8-methyl-6-quinolyl)oxy]-N-(1-isoxazol-3-yl-1-methyl-ethyl)-2-methylsulfanyl-acetamide as an off-white solid.

LC1: rt=1.78 min, m/z=396 ([MH]⁺); ¹H NMR (CDCl₃) δ ppm: 8.82 (1H, d), 8.33 (1H, d), 8.16 (1H, d), 7.43 (1H, bs), 7.35 (1H, d), 7.04 (1H, d), 6.38 (1H, d), 5.55 (1H, s), 3.29 (1H, s), 2.78 (3H, s), 2.20 (3H, s), 1.84 (3H, s), 1.80 (3H, s).

### EXAMPLE 4

This example illustrates the preparation of N-[1-(4-bromoisoxazol-3-yl)-1-methyl-ethyl]-2-[(3-ethynyl-8-methyl-6-quinolyl)oxy]-2-methylsulfanyl-acetamide (compound No. 45 Table 50) according to the Sequence 4 depicted below.

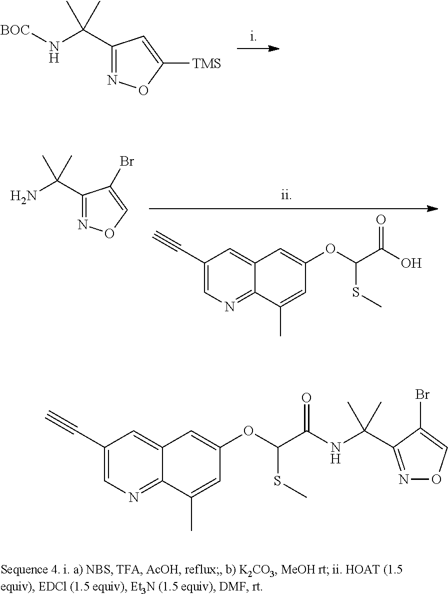

### Step 1: Preparation of 2-(4-bromoisoxazol-3-yl)propan-2-amine

To a suspension of tert-butyl N-[1-methyl-1-(5-trimethylsilylisoxazol-3-yl)ethyl]carbamate (1 mmol, 298 mg) in AcOH (1 mL) was added solid NBS (2 mmol, 356 mg) followed by TFA (2.5 mmol, 0.186 mL) and the reaction was heated to 80° C. for 4 h. The reaction was taken up in EtOAc and washed sequentially with Na₂SO₃ aq., K₂CO₃ aq. brine, dried over MgSO₄, filtered and evaporated. The crude product was dissolved in MeOH (10 mL) and K₂CO₃ (2 g) was added and the reaction was stirred for 1 h at RT. Water (30 mL) was added to the reaction and the resulting mixture was extracted three time with EtOAc. The combined organic phases were dried over MgSO₄, filtered and evaporated to yield 2-(4-bromoisoxazol-3-yl)propan-2-amine as a light yellow oil.

### Step 2: N-[1-(4-bromoisoxazol-3-yl)-1-methyl-ethyl]-2-[(3-ethynyl-8-methyl-6-quinolyl)oxy]-2-methylsulfanyl-acetamide (compound No. 45 Table 50)

To a solution of 2-[(3-ethynyl-8-methyl-6-quinolyl)oxy]-2-methylsulfanyl-acetic acid (0.86 mmol, 144 mg) in DMF (3 mL) was sequentially added Et₃N (0.63 mmol, 0.087 mL), HOAT (0.63 mmol, 85 mg), 2-(4-bromoisoxazol-3-yl)propan-2-amine (0.63 mmol, 103 mg) and EDCI (0.63 mmol, 120 mg). The reaction was then stirred for 16 h at RT. The reaction mixture was taken up in EtOAc and washed three times with brine, dried over MgSO₄, filtered and evaporated. The crude product was purified by column chromatography over SiO₂ (EtOAc/Heptane 1:1) to yield N-[1-(4-bromoisoxazol-3-yl)-1-methyl-ethyl]-2-[(3-ethynyl-8-methyl-6-quinolyl)oxy]-2-methylsulfanyl-acetamide as an off-white solid.

LC1: rt=1.86 min, m/z=476 ([MH]⁺); ¹H NMR (CDCl₃) δ ppm: 8.89 (1H, d), 8.41 (1H, s), 8.19 (1H, d), 7.40 (1H, bs), 7.05 (1H, d), 5.68 (1H, s), 3.27 (1H, s), 2.82 (3H, s), 2.30 (3H, s), 1.88 (3H, s).

### EXAMPLE 5

This example illustrates the preparation of 2-[(3-ethynyl-6-quinolyl)oxy]-N-[1-methyl-1-(4-methyl-2-pyridyl)ethyl]-2-methylsulfanyl-acetamide (compound No. 18 Table 49) according to the Sequence 5 depicted below.

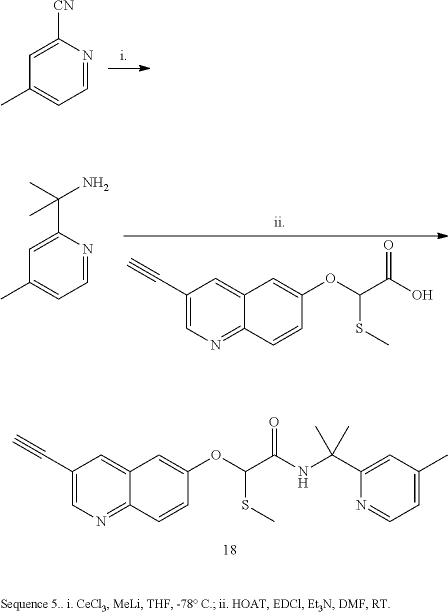

### Step 1: Preparation of 2-(4-methyl-2-pyridyl)propan-2-amine

To a mechanically stirred solution of THF (180 mL) was added anhydrous CeCl₃ (76.5 mmol, 18.8 g) and the mixture was aged at 65° C. for 3.5 h. The mixture was cooled to −78° C. and MeLi (1.6 M in Et2O, 76.5 mmol, 55 mL) was added dropwise over 25 min. The reaction was stirred an additional 30 min at −78° C. before addition of 4-methylpyridine-2-carbonitrile (15.3 mmol, 1.81 g) as a THF solution (25 mL). After addition the reaction was kept 1.5 h at −78° C. before being slowly brought back to RT abd stirred overnight. The reaction was quenched by addition of NH₄Cl sat. aq. solution and ammonium hydroxide (25% in H₂O, 50 mL) added. The reaction mixture was filtered over Celite to remove the precipitate and the filter pad washed with CH₂Cl₂. The combine organic phase were washed with brine, dried over Na₂SO₄, filtered and evaporated. The crude product was purified by column chromatography over SiO₂ (CH₂Cl₂/MeOH/NH₄OH 95:4.5:0.5) to yield 2-(4-methyl-2-pyridyl)propan-2-amine as yellow oil.

¹H NMR (CDCl₃) δ ppm: 8.41 (1H, d), 7.25 (1H, s), 6.94 (1H, d), 2.36 (3H, s), 2.14 (2H, bs), 1.51 (6H, s).

### Step 2: Preparation of 2-[(3-ethynyl-6-quinolyl)oxy]-N-[1-methyl-1-(4-methyl-2-pyridyl)ethyl]-2-methylsulfanyl-acetamide (compound No. 18 Table 49)

To a solution of 2-[(3-ethynyl-6-quinolyl)oxy]-2-methylsulfanyl-acetic acid (1.1 mmol, 301 mg) in DMF (6 mL) was sequentially added Et₃N (1.38 mmol, 0.191 mL), HOAT (1.38 mmol, 187 mg), 2-(4-methyl-2-pyridyl)propan-2-amine (1.38 mmol, 207 mg) and EDCI (1.38 mmol, 264 mg). The reaction was then stirred for 16 h at RT. The reaction mixture was taken up in EtOAc and washed three times with brine, dried over MgSO₄, filtered and evaporated. The crude product was purified by column chromatography over SiO₂ (EtOAc/Heptane 1:1) to yield N-[1-(4-bromoisoxazol-3-yl)-1-methyl-ethyl]-2-[(3-ethynyl-8-methyl-6-quinolyl)oxy]-2-methylsulfanyl-acetamide as an off-white solid.

LC1: rt=1.48 min, m/z=406 ([MH]⁺); Mp=63-65° C.; ¹H NMR (CDCl₃) δ ppm: 9.28 (1H, s), 8.81 (1H, d), 8.39 (1H, d), 8.20 (1H, d), 8.06 (1H, d), 7.57 (1H, dd), 7.20 (1H, s), 7.05 (1H, d), 5.70 (1H, s), 3.29 (1H, s), 2.40 (3H, s), 2.23 (3H, s), 1.84 (3H, s), 1.78 (3H, s).

### EXAMPLE 6

This Example illustrates the preparation of N-[1-methyl-1-(2-pyridyl)ethyl]-2-methylsulfanyl-2-[(3-vinyl-6-quinolyl)oxy]acetamide (compound No. 133 Table 51) according to the Scheme 6 depicted below.

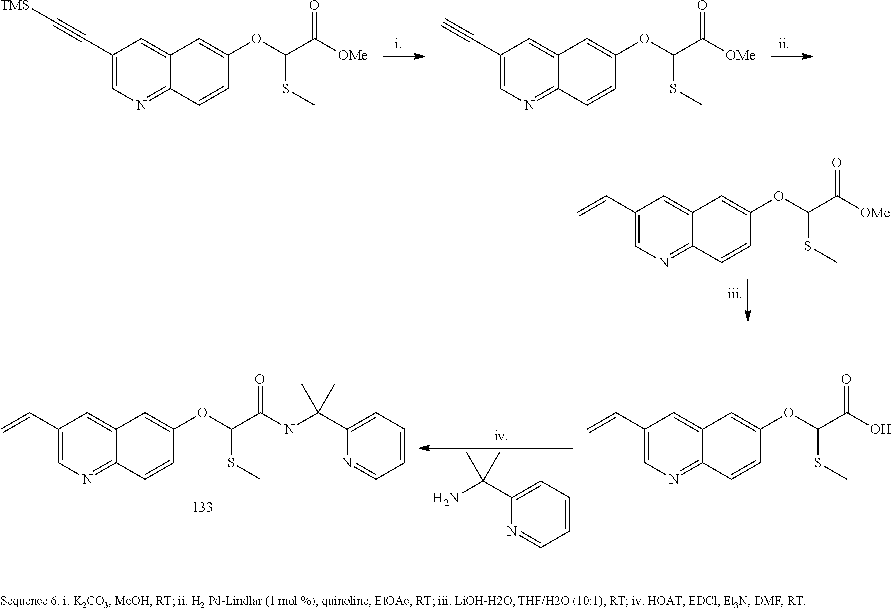

### Step 1: Preparation of methyl 2-[(3-ethynyl-6-quinolyl)oxy]-2-methylsulfanyl-acetate

To a solution of methyl 2-methylsulfanyl-2-[[3-(2-trimethylsilylethynyl)-6-quinolyl]oxy]acetate (21.1 mmol, 7.5 g) in MeOH (100 mL) at RT was added solid K₂CO₃ (25.4 mmol, 3.51 g) an the reaction was stirred for 10 min. It was then taken up into EtOAc, washed twice with brine, dried over MgSO4, filtered and evaporated. The crude product was purified by column chromatography over SiO₂ (EtOAc/Heptane 1:4) to yield methyl 2-[(3-ethynyl-6-quinolyl)oxy]-2-methylsulfanyl-acetate as an off-white solid.

LC1: rt=1.68 min, m/z=288 ([MH]⁺); ¹H NMR (CDCl₃) δ ppm: 8.82 (1H, d), 8.19 (1H, d), 8.05 (1H, d), 7.50 (1H, dd), 7.18 (1H, d), 5.73 (1H, s), 3.88 (3H, s), 3.29 (1H, s), 2.22 (3H, s).

### Step 2: Preparation of methyl 2-methylsulfanyl-2-[(3-vinyl-6-quinolyl)oxy]acetate

To a solution of methyl 2-[(3-ethynyl-6-quinolyl)oxy]-2-methylsulfanyl-acetate (1.57 mmol, 451 mg), quinoline (4.71 mmol, 0.56 mL) and Lindlar's catalyst (60 mg) in EtOAc (20 mL) was bubbled H₂ (1 atm) the reaction was carefully monitored. When full conversion was reached, the mixture was filtered over a pad of Celite and the filter cake was washed with EtOAc. The mother liquor was evaporated and the resulting crude product was purified by column chromatography over SiO₂ (EtOAc/Heptane 1:2) to yield methyl 2-methylsulfanyl-2-[(3-vinyl-6-quinolyl)oxy]acetate as an off-white solid.

LC1: rt=1.60 min, m/z=290 ([MH]⁺); ¹H NMR (CDCl₃) δ ppm: 8.89 (1H, d), 8.02 (1H, d), 7.97 (1H, d), 7.42 (1H, dd), 7.19 (1H, d), 6.82 (1H, dd), 5.98 (1H, d), 5.72 (1H, s), 5.45 (1H, d), 3.89 (3H, s), 2.23 (3H, s).

### Step 3: Preparation of 2-methylsulfanyl-2-[(3-vinyl-6-quinolyl)oxy]acetic acid

To a solution of methyl 2-methylsulfanyl-2-[(3-vinyl-6-quinolyl)oxy]acetate (0.69 mmol, 200 mg) in THF/H₂O (10:1, 3 mL) at 0° C. was added LiOH.H₂O (0.97 mmol, 41 mg). The reaction was allowed to warm to RT and stirred for 1 h. The reaction was acidified to pH 1 with HCl (2M) and a white precipitate formed which was filtered and evaporated to dryness to yield 2-methylsulfanyl-2-[(3-vinyl-6-quinolyl)oxy]acetic acid as an off-white solid.

UPLC: rt=0.67 min, m/z=276 ([MH]⁺); ¹H NMR (d₆-DMSO) δ ppm: 13.5 (1H, bs), 8.92 (1H, d), 8.22 (1H, d), 7.93 (1H, d), 7.44 (1H, dd), 7.41 (1H, s), 6.90 (1H, dd), 6.13 (1H, d), 6.07 (1H, s), 5.47 (1H, d), 2.18 (3H, s).

### Step 4: Preparation of N-[1-methyl-1-(2-pyridyl)ethyl]-2-methylsulfanyl-2-[(3-vinyl-6-quinolyl)oxy]acetamide (compound No. 133 Table 51)

To a solution of 2-methylsulfanyl-2-[(3-vinyl-6-quinolyl)oxy]acetic acid (0.41 mmol, 114 mg) in DMF (2 mL) was sequentially added Et₃N (0.52 mmol, 0.072 mL), HOAT (0.52 mmol, 70 mg), 2-(4-methyl-2-pyridyl)propan-2-amine (0.41 mmol, 56 mg) and EDCI (0.52 mmol, 99 mg). The reaction was then stirred for 16 h at RT. The reaction mixture was taken up in EtOAc and washed three times with brine, dried over MgSO₄, filtered and evaporated. The crude product was purified by column chromatography over SiO₂ (EtOAc/Heptane 1:1) to yield N-[1-methyl-1-(2-pyridyl)ethyl]-2-methylsulfanyl-2-[(3-vinyl-6-quinolyl)oxy]acetamide as an off-white solid.

UPLC: rt=0.79 min, m/z=394 ([MH]⁺); M.p.=95-97° C.; ¹H NMR (CDCl₃) δ ppm: 9.21 (1H, s), 8.90 (1H, d), 8.53 (1H, d), 8.06 (1H, d), 8.00 (1H, s), 7.72 (1H, t), 7.52 (1H, dd), 7.40 (1H, d), 7.29 (1H, d), 7.23 (1H, t), 6.85 (1H, dd), 5.99 (1H, d), 5.70 (1H, s), 5.49 (1H, d), 2.22 (3H, s), 1.84 (3H, s), 1.79 (3H, s).

TABLE 49

| Compound | | M.P. | M.P. |
|---|---|---|---|
| No. | Structure | Low | High |
| 1 | 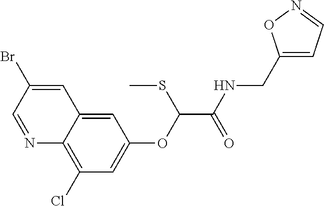 [SMILES: CSC(Oc1cc(Cl)c2ncc(Br)cc2c1)C(=O)NCc1ccno1] | 143 | 147 |
| 2 | 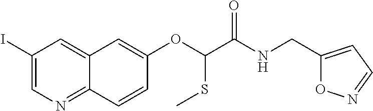 [SMILES: CSC(Oc1ccc2ncc(I)cc2c1)C(=O)NCc1ccno1] | 153 | 155 |
| 3 | 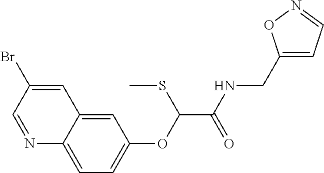 [SMILES: CSC(Oc1ccc2ncc(Br)cc2c1)C(=O)NCc1ccno1] | 140 | 143 |
| 4 | 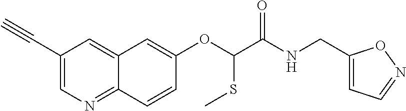 [SMILES: C#Cc1cnc2ccc(OC(SC)C(=O)NCc3ccno3)cc2c1] | 115 | 118 |
| 5 | 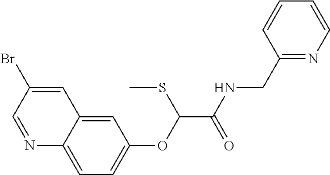 [SMILES: CSC(Oc1ccc2ncc(Br)cc2c1)C(=O)NCc1ccccn1] | 104 | 106 |
| 6 | 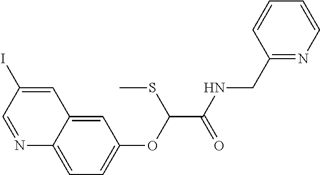 [SMILES: CSC(Oc1ccc2ncc(I)cc2c1)C(=O)NCc1ccccn1] | 109 | 113 |
| 7 | 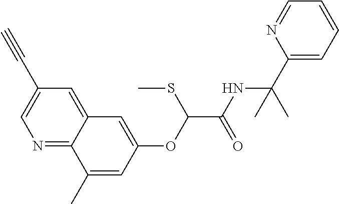 [SMILES: C#Cc1cnc2c(C)cc(OC(SC)C(=O)NC(C)(C)c3ccccn3)cc2c1] | 113 | 117 |
| 8 | 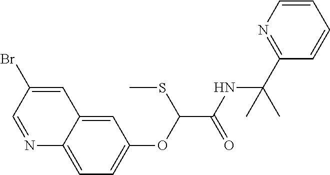 [SMILES: CSC(Oc1ccc2ncc(Br)cc2c1)C(=O)NC(C)(C)c1ccccn1] | 105 | 110 |
| 9 | 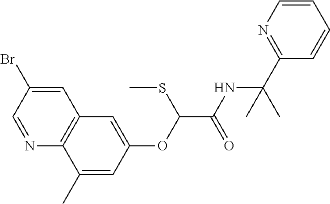 [SMILES: CSC(Oc1cc(C)c2ncc(Br)cc2c1)C(=O)NC(C)(C)c1ccccn1] | 123 | 125 |
| 10 | 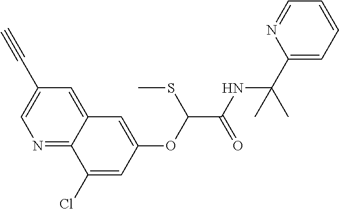 [SMILES: C#Cc1cnc2c(Cl)cc(OC(SC)C(=O)NC(C)(C)c3ccccn3)cc2c1] | 153 | 156 |
| 11 | 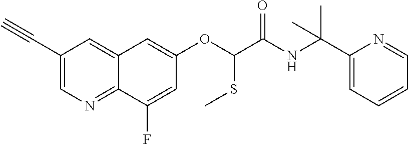 [SMILES: C#Cc1cnc2c(F)cc(OC(SC)C(=O)NC(C)(C)c3ccccn3)cc2c1] | 125 | 127 |
| 12 | 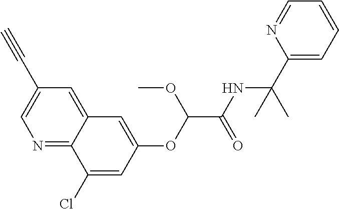 [SMILES: C#Cc1cnc2c(Cl)cc(OC(OC)C(=O)NC(C)(C)c3ccccn3)cc2c1] | 108 | 110 |
| 13 | 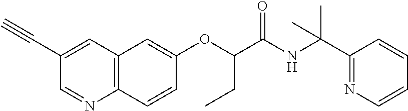 [SMILES: C#Cc1cnc2ccc(OC(CC)C(=O)NC(C)(C)c3ccccn3)cc2c1] | 96 | 98 |
| 14 | 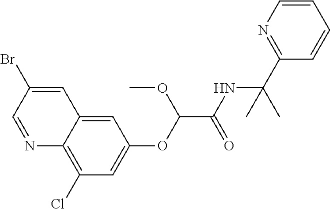 [SMILES: COC(Oc1cc(Cl)c2ncc(Br)cc2c1)C(=O)NC(C)(C)c1ccccn1] | 95 | 98 |
| 15 | 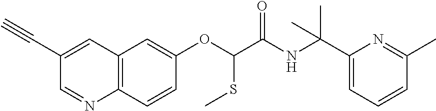 [SMILES: C#Cc1cnc2ccc(OC(SC)C(=O)NC(C)(C)c3cccc(C)n3)cc2c1] | 148 | 150 |
| 16 | 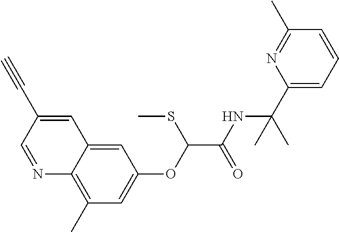 [SMILES: C#Cc1cnc2c(C)cc(OC(SC)C(=O)NC(C)(C)c3cccc(C)n3)cc2c1] | 123 | 125 |
| 17 | 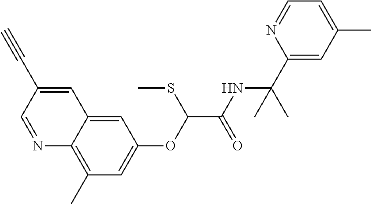 [SMILES: C#Cc1cnc2c(C)cc(OC(SC)C(=O)NC(C)(C)c3cc(C)ccn3)cc2c1] | 82 | 85 |
| 18 | 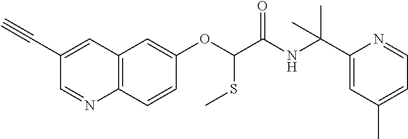 [SMILES: C#Cc1cnc2ccc(OC(SC)C(=O)NC(C)(C)c3cc(C)ccn3)cc2c1] | 63 | 65 |
| 19 | 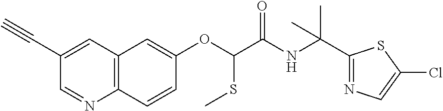 [SMILES: C#Cc1cnc2ccc(OC(SC)C(=O)NC(C)(C)c3ncc(Cl)s3)cc2c1] | 125 | 127 |
| 20 | 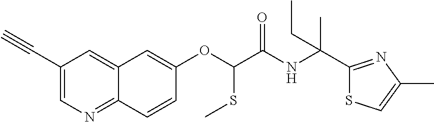 [SMILES: C#Cc1cnc2ccc(OC(SC)C(=O)NC(C)(CC)c3nc(C)cs3)cc2c1] | 120 | 122 |
| 21 | 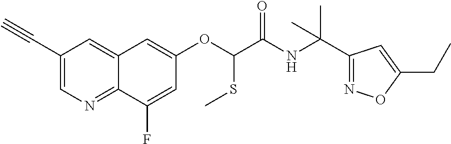 [SMILES: C#Cc1cnc2c(F)cc(OC(SC)C(=O)NC(C)(C)c3cc(CC)on3)cc2c1] | 133 | 137 |
| 22 | 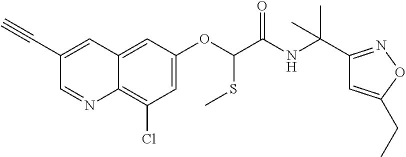 [SMILES: C#Cc1cnc2c(Cl)cc(OC(SC)C(=O)NC(C)(C)c3cc(CC)on3)cc2c1] | 157 | 165 |
| 23 | 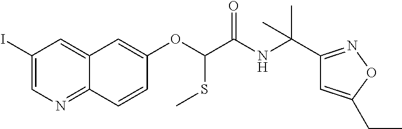 [SMILES: CCc1cc(C(C)(C)NC(=O)C(Oc2ccc3ncc(I)cc3c2)SC)no1] | 125 | 132 |
| 24 | 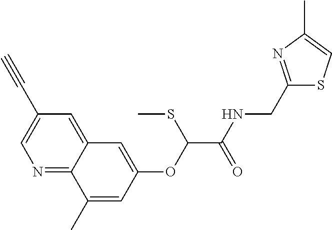 [SMILES: C#Cc1cnc2c(C)cc(OC(SC)C(=O)NCc3nc(C)cs3)cc2c1] | 148 | 149 |
| 25 | 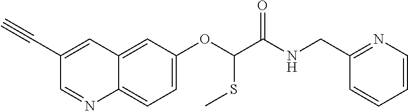 [SMILES: C#Cc1cnc2ccc(OC(SC)C(=O)NCc3ccccn3)cc2c1] | 133 | 135 |
| 26 | 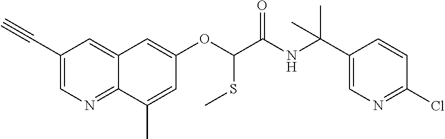 [SMILES: C#Cc1cnc2c(C)cc(OC(SC)C(=O)NC(C)(C)c3ccc(Cl)nc3)cc2c1] | 120 | 123 |
| 27 | 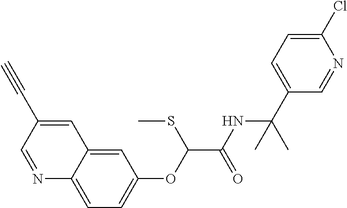 [SMILES: C#Cc1cnc2ccc(OC(SC)C(=O)NC(C)(C)c3ccc(Cl)nc3)cc2c1] | 114 | 115 |
| 28 | 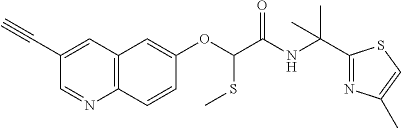 [SMILES: C#Cc1cnc2ccc(OC(SC)C(=O)NC(C)(C)c3nc(C)cs3)cc2c1] | 97 | 99 |
| 29 | 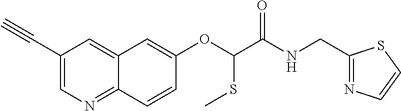 [SMILES: C#Cc1cnc2ccc(OC(SC)C(=O)NCc3nccs3)cc2c1] | 178 | 180 |
| 30 | 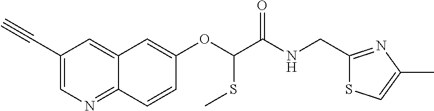 [SMILES: C#Cc1cnc2ccc(OC(SC)C(=O)NCc3nc(C)cs3)cc2c1] | 115 | 116 |
| 31 | 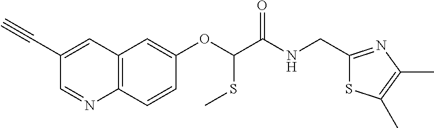 [SMILES: C#Cc1cnc2ccc(OC(SC)C(=O)NCc3nc(C)c(C)s3)cc2c1] | 126 | 128 |
| 32 | 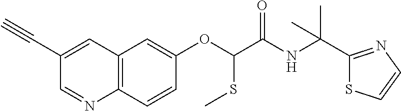 [SMILES: C#Cc1cnc2ccc(OC(SC)C(=O)NC(C)(C)c3nccs3)cc2c1] | 123 | 125 |

This table gives analytical data (melting point) for compounds of Tables 1-48

TABLE 50

| Compound | | LC-MS | m/z | |
|---|---|---|---|---|
| No. | Structural formula | rt (min) | (M + 1)) | |
| 33 | 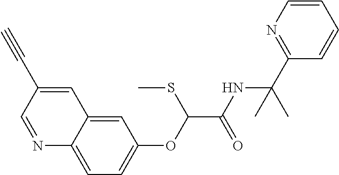 [SMILES: C#Cc1cnc2ccc(OC(SC)C(=O)NC(C)(C)c3ccccn3)cc2c1] | 1.62 | 392 | |
| 34 | 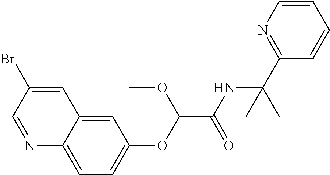 [SMILES: COC(Oc1ccc2ncc(Br)cc2c1)C(=O)NC(C)(C)c1ccccn1] | 1.65 | 432 | |
| 35 | 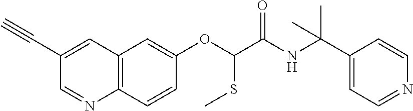 [SMILES: C#Cc1cnc2ccc(OC(SC)C(=O)NC(C)(C)c3ccncc3)cc2c1] | 1.16 | 392 | |
| 36 | 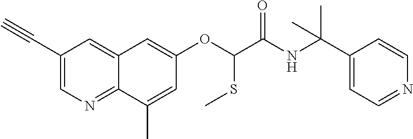 [SMILES: C#Cc1cnc2c(C)cc(OC(SC)C(=O)NC(C)(C)c3ccncc3)cc2c1] | 1.32 | 406 | |
| 37 | 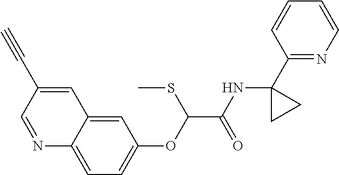 [SMILES: C#Cc1cnc2ccc(OC(SC)C(=O)NC3(c4ccccn4)CC3)cc2c1] | 1.52 | 390 | |
| 38 | 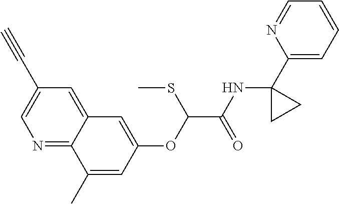 [SMILES: C#Cc1cnc2c(C)cc(OC(SC)C(=O)NC3(c4ccccn4)CC3)cc2c1] | 1.67 | 404 | |
| 39 | 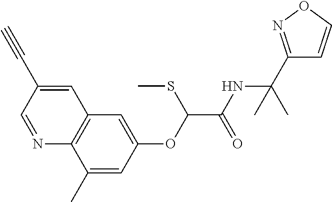 [SMILES: C#Cc1cnc2c(C)cc(OC(SC)C(=O)NC(C)(C)c3ccon3)cc2c1] | 1.76 | 396 | |
| 40 | 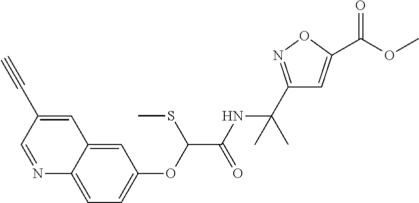 [SMILES: C#Cc1cnc2ccc(OC(SC)C(=O)NC(C)(C)c3cc(C(=O)OC)on3)cc2c1] | 1.54 | 440 | LC1 |
| 41 | 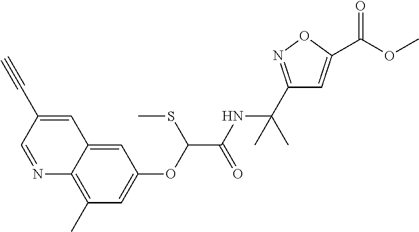 [SMILES: C#Cc1cnc2c(C)cc(OC(SC)C(=O)NC(C)(C)c3cc(C(=O)OC)on3)cc2c1] | 1.68 | 454 | LC1 |
| 42 | 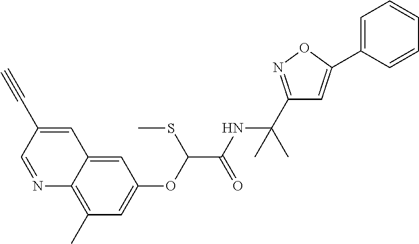 [SMILES: C#Cc1cnc2c(C)cc(OC(SC)C(=O)NC(C)(C)c3cc(-c4ccccc4)on3)cc2c1] | 1.89 | 472 | LC1 |
| 43 | 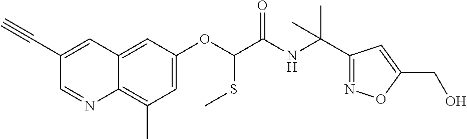 [SMILES: C#Cc1cnc2c(C)cc(OC(SC)C(=O)NC(C)(C)c3cc(CO)on3)cc2c1] | 1.66 | 426 | LC1 |
| 44 | 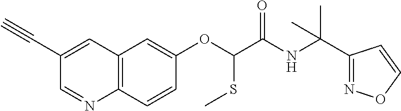 [SMILES: C#Cc1cnc2ccc(OC(SC)C(=O)NC(C)(C)c3ccon3)cc2c1] | 1.63 | 382 | LC1 |
| 45 | 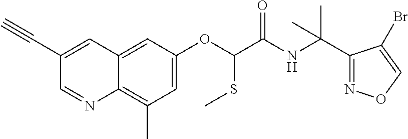 [SMILES: C#Cc1cnc2c(C)cc(OC(SC)C(=O)NC(C)(C)c3nocc3Br)cc2c1] | 1.86 | 476 | LC1 |
| 46 | 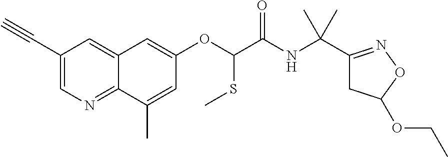 [SMILES: C#Cc1cnc2c(C)cc(OC(SC)C(=O)NC(C)(C)C3=NOC(OCC)C3)cc2c1] | 1.82 | 442 | LC1 |
| 47 | 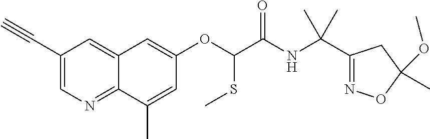 [SMILES: C#Cc1cnc2c(C)cc(OC(SC)C(=O)NC(C)(C)C3=NOC(C)(OC)C3)cc2c1] | 1.78 | 442 | LC1 |
| 48 | 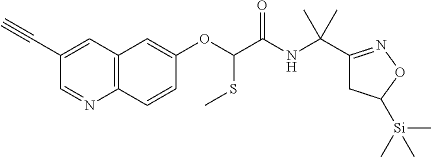 [SMILES: C#Cc1cnc2ccc(OC(SC)C(=O)NC(C)(C)C3=NOC([Si](C)(C)C)C3)cc2c1] | 1.89 | 456 | LC1 |
| 49 | 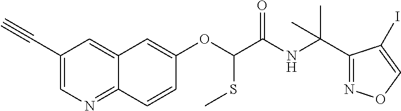 [SMILES: C#Cc1cnc2ccc(OC(SC)C(=O)NC(C)(C)c3nocc3I)cc2c1] | 1.76 | 508 | |
| 50 | 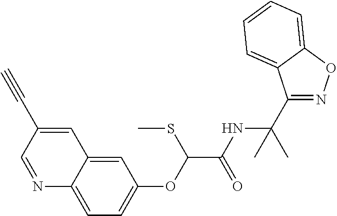 [SMILES: C#Cc1cnc2ccc(OC(SC)C(=O)NC(C)(C)c3noc4ccccc34)cc2c1] | 1.79 | 432 | |
| 51 | 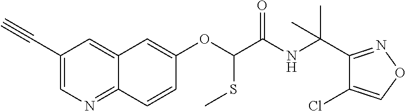 [SMILES: C#Cc1cnc2ccc(OC(SC)C(=O)NC(C)(C)c3nocc3Cl)cc2c1] | 1.74 | 416 | |
| 52 | 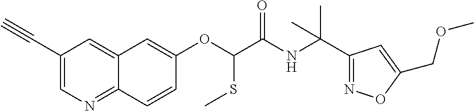 [SMILES: C#Cc1cnc2ccc(OC(SC)C(=O)NC(C)(C)c3cc(COC)on3)cc2c1] | 1.67 | 426 | |
| 53 | 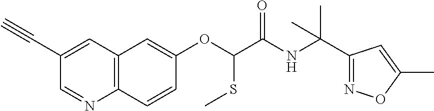 [SMILES: C#Cc1cnc2ccc(OC(SC)C(=O)NC(C)(C)c3cc(C)on3)cc2c1] | 1.68 | 396 | |
| 54 | 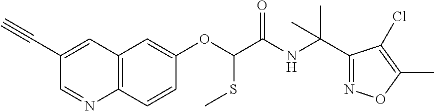 [SMILES: C#Cc1cnc2ccc(OC(SC)C(=O)NC(C)(C)c3noc(C)c3Cl)cc2c1] | 1.81 | 430 | |
| 55 | 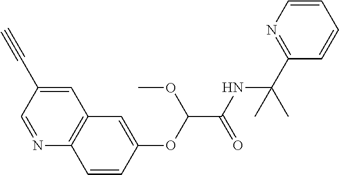 [SMILES: C#Cc1cnc2ccc(OC(OC)C(=O)NC(C)(C)c3ccccn3)cc2c1] | 1.53 | 376 | |
| 56 | 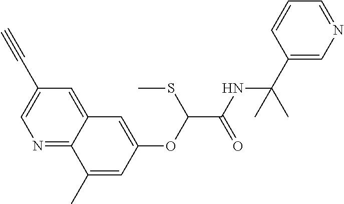 [SMILES: C#Cc1cnc2c(C)cc(OC(SC)C(=O)NC(C)(C)c3cccnc3)cc2c1] | 1.39 | 406 | |
| 57 | 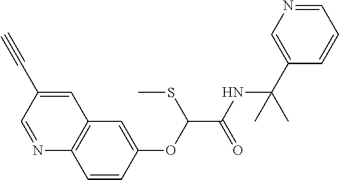 [SMILES: C#Cc1cnc2ccc(OC(SC)C(=O)NC(C)(C)c3cccnc3)cc2c1] | 1.23 | 392 | |
| 58 | 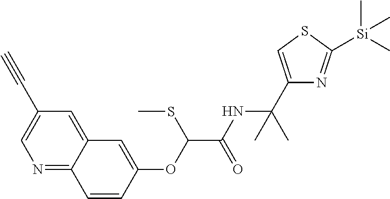 [SMILES: C#Cc1cnc2ccc(OC(SC)C(=O)NC(C)(C)c3csc([Si](C)(C)C)n3)cc2c1] | 2.03 | 470 | |
| 59 | 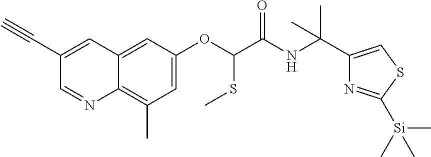 [SMILES: C#Cc1cnc2c(C)cc(OC(SC)C(=O)NC(C)(C)c3csc([Si](C)(C)C)n3)cc2c1] | 2.14 | 484 | |
| 60 | 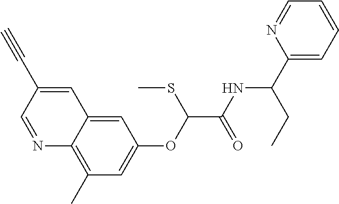 [SMILES: C#Cc1cnc2c(C)cc(OC(SC)C(=O)NC(CC)c3ccccn3)cc2c1] | 1.77 | 406 | |
| 61 | 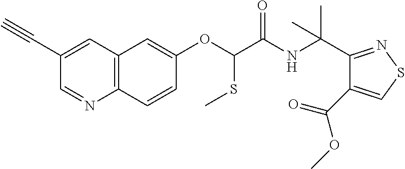 [SMILES: C#Cc1cnc2ccc(OC(SC)C(=O)NC(C)(C)c3nscc3C(=O)OC)cc2c1] | 1.86 | 456 | |
| 62 | 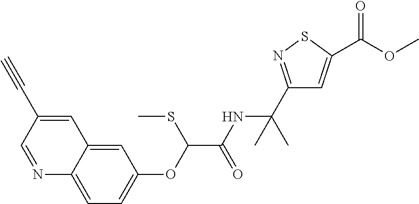 [SMILES: C#Cc1cnc2ccc(OC(SC)C(=O)NC(C)(C)c3cc(C(=O)OC)sn3)cc2c1] | 1.81 | 456 | |
| 63 | 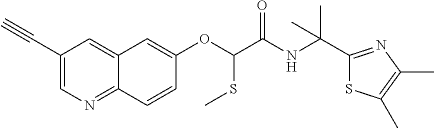 [SMILES: C#Cc1cnc2ccc(OC(SC)C(=O)NC(C)(C)c3nc(C)c(C)s3)cc2c1] | 1.84 | 426 | |
| 64 | 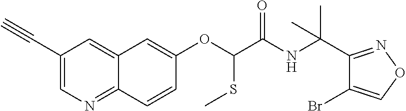 [SMILES: C#Cc1cnc2ccc(OC(SC)C(=O)NC(C)(C)c3nocc3Br)cc2c1] | 1.78 | 462 | |
| 65 | 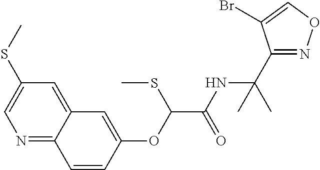 [SMILES: CSc1cnc2ccc(OC(SC)C(=O)NC(C)(C)c3nocc3Br)cc2c1] | 1.76 | 484 | |
| 66 | 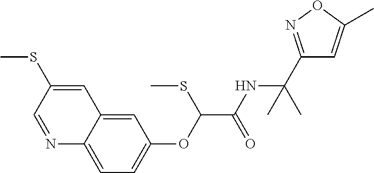 | 1.70 | 418 | |
| 67 | 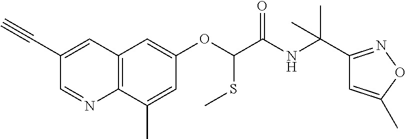 [SMILES: C#Cc1cnc2c(C)cc(OC(SC)C(=O)NC(C)(C)c3cc(C)on3)cc2c1] | 1.86 | 410 | |
| 68 | 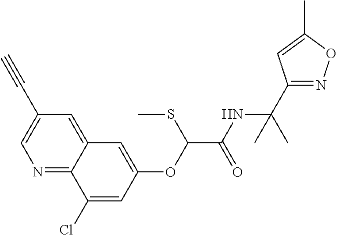 [SMILES: C#Cc1cnc2c(Cl)cc(OC(SC)C(=O)NC(C)(C)c3cc(C)on3)cc2c1] | 1.83 | 430 | |
| 69 | 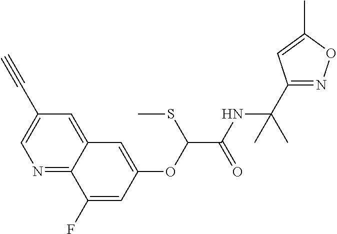 [SMILES: C#Cc1cnc2c(F)cc(OC(SC)C(=O)NC(C)(C)c3cc(C)on3)cc2c1] | 1.75 | 414 | |
| 70 | 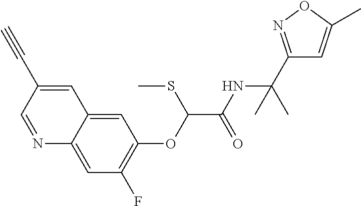 [SMILES: C#Cc1cnc2cc(F)c(OC(SC)C(=O)NC(C)(C)c3cc(C)on3)cc2c1] | 1.79 | 414 | |
| 71 | 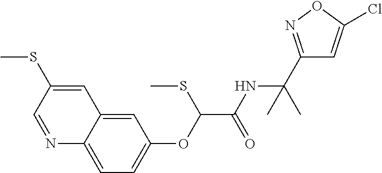 [SMILES: CSc1cnc2ccc(OC(SC)C(=O)NC(C)(C)c3cc(Cl)on3)cc2c1] | 1.81 | 438 | |
| 72 | 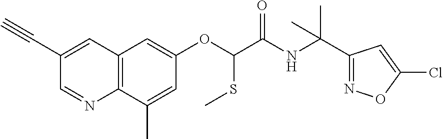 [SMILES: C#Cc1cnc2c(C)cc(OC(SC)C(=O)NC(C)(C)c3cc(Cl)on3)cc2c1] | 1.91 | 430 | |
| 73 | 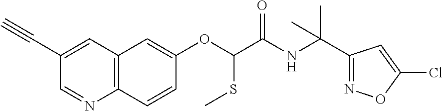 [SMILES: C#Cc1cnc2ccc(OC(SC)C(=O)NC(C)(C)c3cc(Cl)on3)cc2c1] | 1.78 | 416 | |
| 74 | 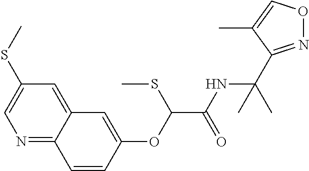 [SMILES: CSc1cnc2ccc(OC(SC)C(=O)NC(C)(C)c3nocc3C)cc2c1] | 1.70 | 418 | |
| 75 | 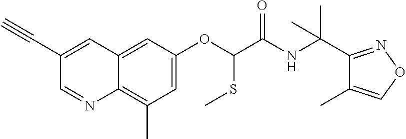 [SMILES: C#Cc1cnc2c(C)cc(OC(SC)C(=O)NC(C)(C)c3nocc3C)cc2c1] | 1.69 | 410 | |
| 76 | 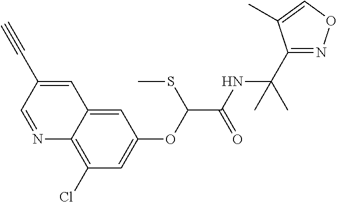 [SMILES: C#Cc1cnc2c(Cl)cc(OC(SC)C(=O)NC(C)(C)c3nocc3C)cc2c1] | 1.81 | 430 | |
| 77 | 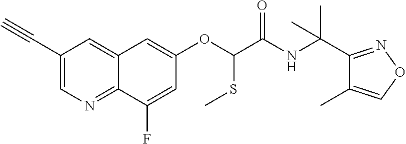 [SMILES: C#Cc1cnc2c(F)cc(OC(SC)C(=O)NC(C)(C)c3nocc3C)cc2c1] | 1.72 | 414 | |
| 78 | 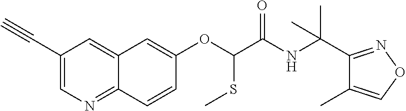 [SMILES: C#Cc1cnc2ccc(OC(SC)C(=O)NC(C)(C)c3nocc3C)cc2c1] | 1.69 | 396 | |
| 79 | 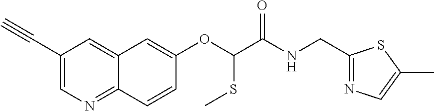 [SMILES: C#Cc1cnc2ccc(OC(SC)C(=O)NCc3ncc(C)s3)cc2c1] | 1.60 | 384 | |

This table gives analytical data (LC MS) for compounds of Tables 1-48. The LC-MS data for this table has been obtained with the LC-MS method

TABLE 51

| Compound | | LC-MS rt | m/z | |
|---|---|---|---|---|
| No. | Structural formula | (min) | ([MH]⁺) | LC-Method |
| 80 | 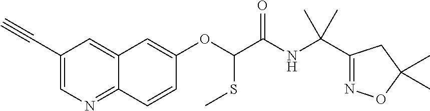 [SMILES: C#Cc1cnc2ccc(OC(SC)C(=O)NC(C)(C)C3=NOC(C)(C)C3)cc2c1] | 1.52 | 412 | LC3-short |
| 81 | 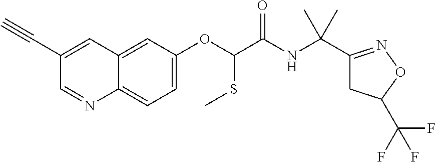 [SMILES: C#Cc1cnc2ccc(OC(SC)C(=O)NC(C)(C)C3=NOC(C(F)(F)F)C3)cc2c1] | 1.71 | 452 | UPLC |
| 82 | 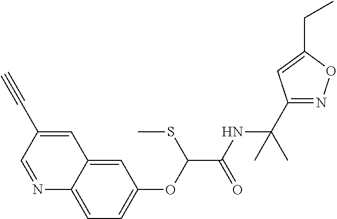 [SMILES: C#Cc1cnc2ccc(OC(SC)C(=O)NC(C)(C)c3cc(CC)on3)cc2c1] | 1.18 | 410 | LC3-long |
| 83 | 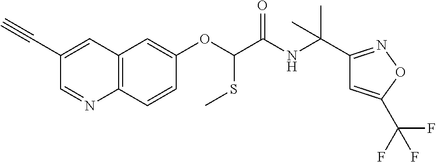 [SMILES: C#Cc1cnc2ccc(OC(SC)C(=O)NC(C)(C)c3cc(C(F)(F)F)on3)cc2c1] | 2.12 | 450 | LC3-long |
| 84 | 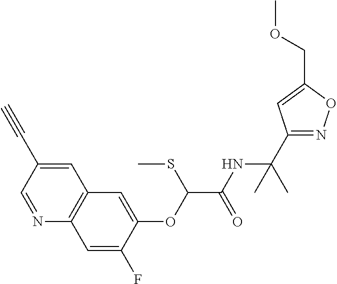 [SMILES: C#Cc1cnc2cc(F)c(OC(SC)C(=O)NC(C)(C)c3cc(COC)on3)cc2c1] | 1.62 | 444 | LC3-long |
| 85 | 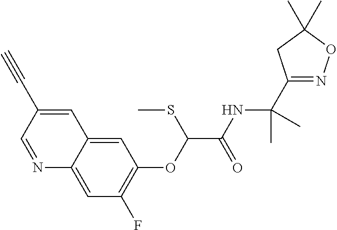 [SMILES: C#Cc1cnc2cc(F)c(OC(SC)C(=O)NC(C)(C)C3=NOC(C)(C)C3)cc2c1] | 1.72 | 430 | UPLC |
| 86 | 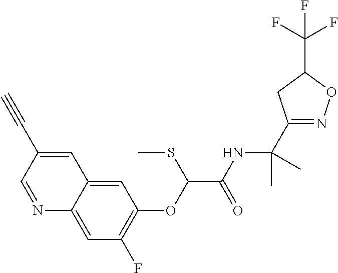 [SMILES: C#Cc1cnc2cc(F)c(OC(SC)C(=O)NC(C)(C)C3=NOC(C(F)(F)F)C3)cc2c1] | 1.95 | 470 | UPLC |
| 87 | 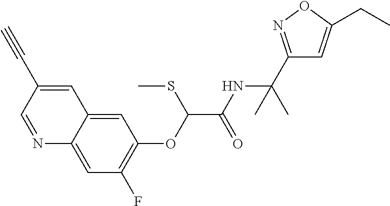 [SMILES: C#Cc1cnc2cc(F)c(OC(SC)C(=O)NC(C)(C)c3cc(CC)on3)cc2c1] | 2.04 | 428 | LC3-long |
| 88 | 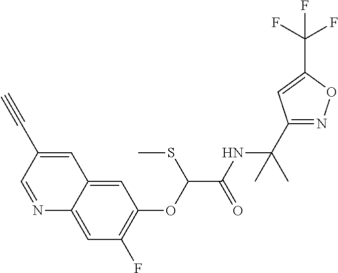 [SMILES: C#Cc1cnc2cc(F)c(OC(SC)C(=O)NC(C)(C)c3cc(C(F)(F)F)on3)cc2c1] | 2.34 | 468 | LC3-long |
| 89 | 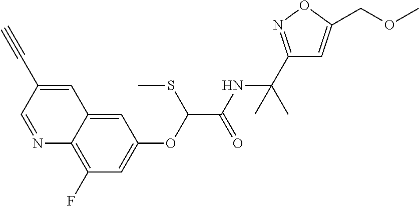 [SMILES: C#Cc1cnc2c(F)cc(OC(SC)C(=O)NC(C)(C)c3cc(COC)on3)cc2c1] | 1.48 | 444 | LC3-long |
| 90 | 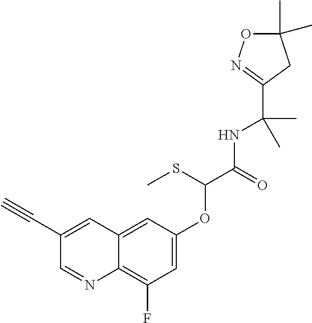 [SMILES: C#Cc1cnc2c(F)cc(OC(SC)C(=O)NC(C)(C)C3=NOC(C)(C)C3)cc2c1] | 1.56 | 430 | LC3-short |
| 91 | 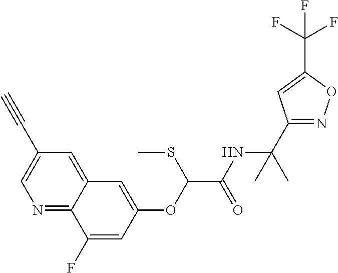 [SMILES: C#Cc1cnc2c(F)cc(OC(SC)C(=O)NC(C)(C)c3cc(C(F)(F)F)on3)cc2c1] | 2.24 | 468 | LC3-long |
| 92 | 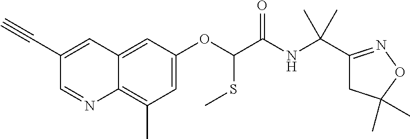 [SMILES: C#Cc1cnc2c(C)cc(OC(SC)C(=O)NC(C)(C)C3=NOC(C)(C)C3)cc2c1] | 1.96 | 426 | LC3-short |
| 93 | 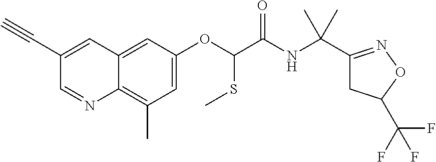 [SMILES: C#Cc1cnc2c(C)cc(OC(SC)C(=O)NC(C)(C)C3=NOC(C(F)(F)F)C3)cc2c1] | 3.24 | 465 | UPLC |
| 94 | 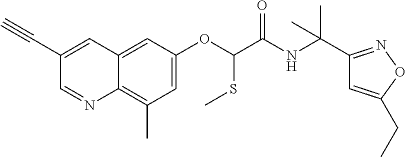 [SMILES: C#Cc1cnc2c(C)cc(OC(SC)C(=O)NC(C)(C)c3cc(CC)on3)cc2c1] | 2.23 | 424 | LC3-long |
| 95 | 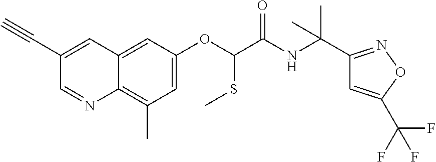 [SMILES: C#Cc1cnc2c(C)cc(OC(SC)C(=O)NC(C)(C)c3cc(C(F)(F)F)on3)cc2c1] | 2.53 | 464 | LC3-long |
| 96 | 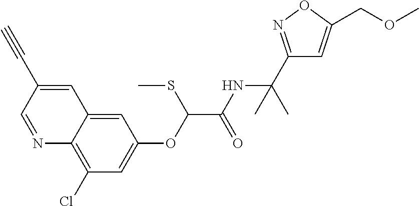 [SMILES: C#Cc1cnc2c(Cl)cc(OC(SC)C(=O)NC(C)(C)c3cc(COC)on3)cc2c1] | 1.83 | 460 | LC3-long |
| 97 | 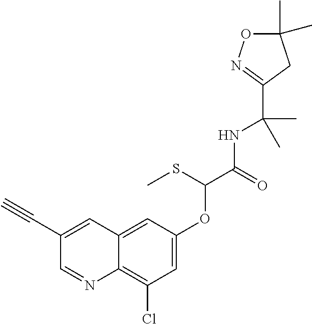 [SMILES: C#Cc1cnc2c(Cl)cc(OC(SC)C(=O)NC(C)(C)C3=NOC(C)(C)C3)cc2c1] | 1.88 | 446 | LC3-short |
| 98 | 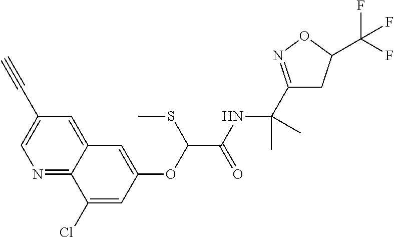 [SMILES: C#Cc1cnc2c(Cl)cc(OC(SC)C(=O)NC(C)(C)C3=NOC(C(F)(F)F)C3)cc2c1] | 2.10 | 486 | UPLC |
| 99 | 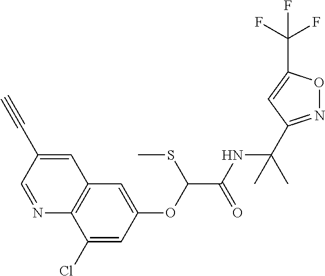 [SMILES: C#Cc1cnc2c(Cl)cc(OC(SC)C(=O)NC(C)(C)c3cc(C(F)(F)F)on3)cc2c1] | 2.50 | 484 | LC3-long |
| 100 | 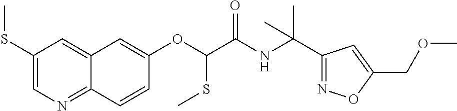 [SMILES: COCc1cc(C(C)(C)NC(=O)C(Oc2ccc3ncc(SC)cc3c2)SC)no1] | 1.39 | 448 | LC3-long |
| 101 | 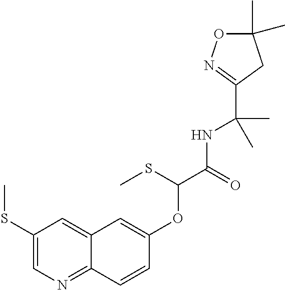 [SMILES: CSc1cnc2ccc(OC(SC)C(=O)NC(C)(C)C3=NOC(C)(C)C3)cc2c1] | 1.44 | 434 | LC2 |
| 102 | 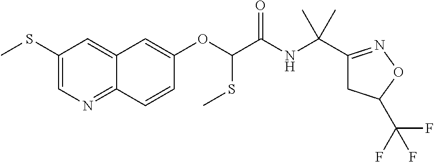 [SMILES: CSc1cnc2ccc(OC(SC)C(=O)NC(C)(C)C3=NOC(C(F)(F)F)C3)cc2c1] | 1.72 | 474 | LC3-short |
| 103 | 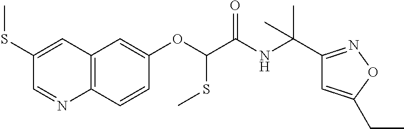 [SMILES: CCc1cc(C(C)(C)NC(=O)C(Oc2ccc3ncc(SC)cc3c2)SC)no1] | 1.81 | 432 | LC3-long |
| 104 | 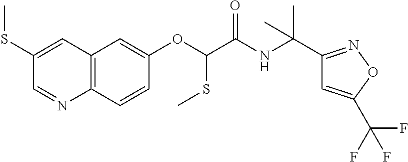 [SMILES: CSc1cnc2ccc(OC(SC)C(=O)NC(C)(C)c3cc(C(F)(F)F)on3)cc2c1] | 2.20 | 472 | LC3-long |
| 105 | 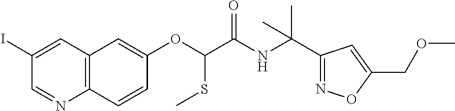 [SMILES: COCc1cc(C(C)(C)NC(=O)C(Oc2ccc3ncc(I)cc3c2)SC)no1] | 1.87 | 528 | LC3-long |
| 106 | 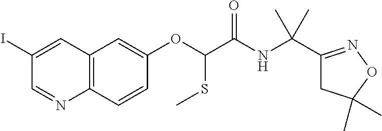 [SMILES: CSC(Oc1ccc2ncc(I)cc2c1)C(=O)NC(C)(C)C1=NOC(C)(C)C1] | 1.85 | 514 | LC2 |
| 107 | 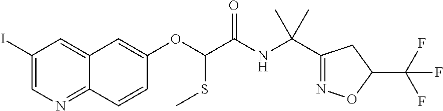 [SMILES: CSC(Oc1ccc2ncc(I)cc2c1)C(=O)NC(C)(C)C1=NOC(C(F)(F)F)C1] | 2.10 | 554 | LC3-short |
| 108 | 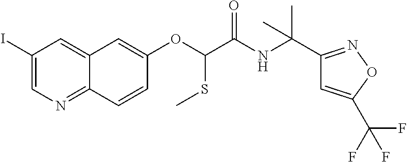 [SMILES: CSC(Oc1ccc2ncc(I)cc2c1)C(=O)NC(C)(C)c1cc(C(F)(F)F)on1] | 2.46 | 552 | LC3-long |
| 109 | 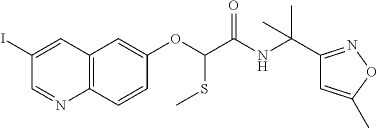 [SMILES: CSC(Oc1ccc2ncc(I)cc2c1)C(=O)NC(C)(C)c1cc(C)on1] | 1.89 | 498 | UPLC |
| 110 | 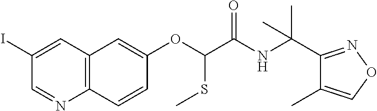 [SMILES: CSC(Oc1ccc2ncc(I)cc2c1)C(=O)NC(C)(C)c1nocc1C] | 1.64 | 498 | LC3-long |
| 111 | 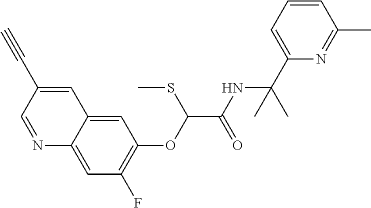 [SMILES: C#Cc1cnc2cc(F)c(OC(SC)C(=O)NC(C)(C)c3cccc(C)n3)cc2c1] | 1.26 | 424 | LC3-long |
| 112 | 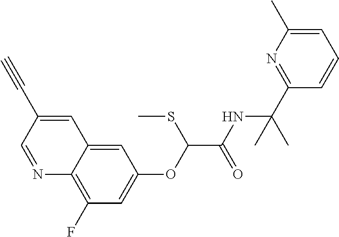 [SMILES: C#Cc1cnc2c(F)cc(OC(SC)C(=O)NC(C)(C)c3cccc(C)n3)cc2c1] | 1.76 | 440 | LC3-long |
| 113 | 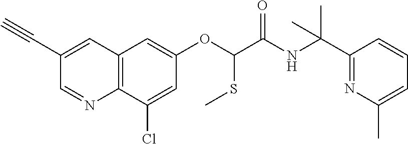 [SMILES: C#Cc1cnc2c(Cl)cc(OC(SC)C(=O)NC(C)(C)c3cccc(C)n3)cc2c1] | 1.76 | 440 | LC3-long |
| 114 | 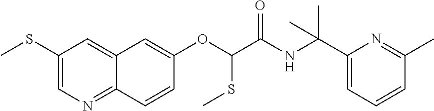 | 1.28 | 428 | LC3-long |
| 115 | 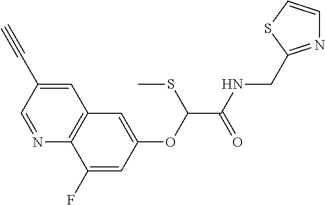 [SMILES: C#Cc1cnc2c(F)cc(OC(SC)C(=O)NCc3nccs3)cc2c1] | 1.18 | 388 | LC3-long |
| 116 | 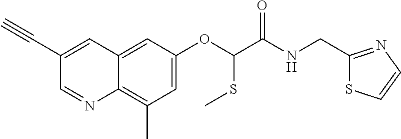 [SMILES: C#Cc1cnc2c(C)cc(OC(SC)C(=O)NCc3nccs3)cc2c1] | 1.32 | 384 | LC3-long |
| 117 | 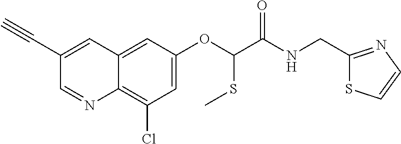 [SMILES: C#Cc1cnc2c(Cl)cc(OC(SC)C(=O)NCc3nccs3)cc2c1] | 1.30 | 404 | LC3-long |
| 118 | 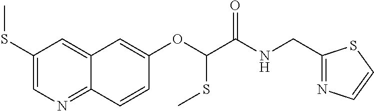 [SMILES: CSc1cnc2ccc(OC(SC)C(=O)NCc3nccs3)cc2c1] | 1.14 | 392 | LC3-long |
| 119 | 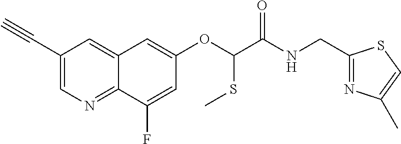 [SMILES: C#Cc1cnc2c(F)cc(OC(SC)C(=O)NCc3nc(C)cs3)cc2c1] | 1.28 | 402 | LC3-long |
| 120 | 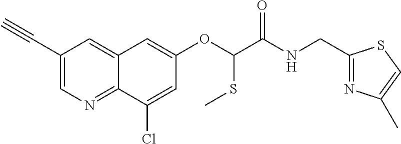 [SMILES: C#Cc1cnc2c(Cl)cc(OC(SC)C(=O)NCc3nc(C)cs3)cc2c1] | 1.38 | 418 | UPLC |
| 121 | 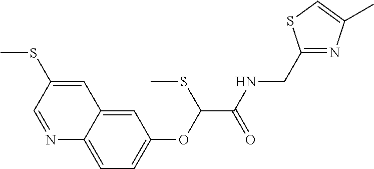 | 1.24 | 406 | UPLC |
| 122 | 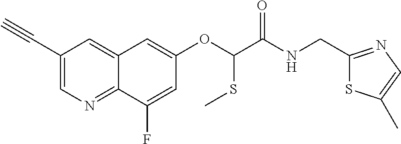 [SMILES: C#Cc1cnc2c(F)cc(OC(SC)C(=O)NCc3ncc(C)s3)cc2c1] | 1.28 | 402 | UPLC |
| 123 | 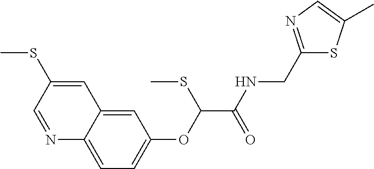 | 1.25 | 406 | UPLC |
| 124 | 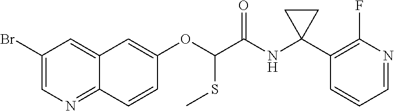 [SMILES: CSC(Oc1ccc2ncc(Br)cc2c1)C(=O)NC1(c2cccnc2F)CC1] | 1.74 | 464 | LC1 |
| 125 | 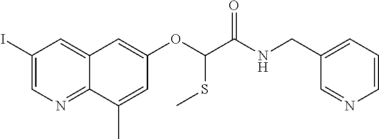 [SMILES: CSC(Oc1cc(C)c2ncc(I)cc2c1)C(=O)NCc1cccnc1] | 1.1 | 480 | LC3-long |
| 126 | 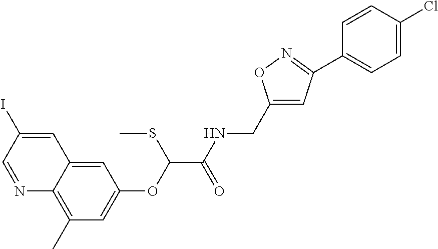 [SMILES: CSC(Oc1cc(C)c2ncc(I)cc2c1)C(=O)NCc1cc(-c2ccc(Cl)cc2)no1] | 2.1 | 580 | LC3-long |
| 127 | 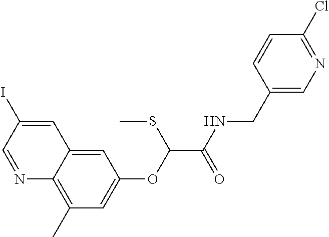 [SMILES: CSC(Oc1cc(C)c2ncc(I)cc2c1)C(=O)NCc1ccc(Cl)nc1] | 1.72 | 514 | LC3-long |
| 128 | 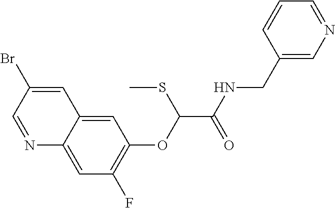 [SMILES: CSC(Oc1cc2cc(Br)cnc2cc1F)C(=O)NCc1cccnc1] | 0.85 | 438 | LC3-long |
| 129 | 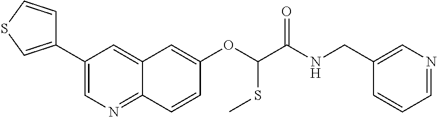 [SMILES: CSC(Oc1ccc2ncc(-c3ccsc3)cc2c1)C(=O)NCc1cccnc1] | 0.75 | 422 | LC3-long |
| 130 | 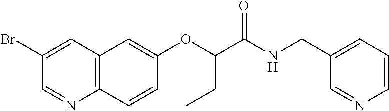 [SMILES: CCC(Oc1ccc2ncc(Br)cc2c1)C(=O)NCc1cccnc1] | 0.68 | 402 | LC3-long |
| 131 | 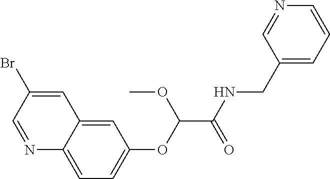 [SMILES: COC(Oc1ccc2ncc(Br)cc2c1)C(=O)NCc1cccnc1] | 0.36 | 404 | LC3-long |
| 132 | 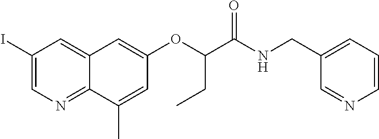 [SMILES: CCC(Oc1cc(C)c2ncc(I)cc2c1)C(=O)NCc1cccnc1] | 0.91 | 462 | LC3-long |
| 133 | 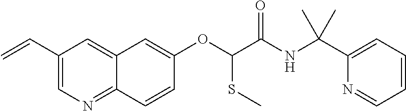 [SMILES: C=Cc1cnc2ccc(OC(SC)C(=O)NC(C)(C)c3ccccn3)cc2c1] | 0.79 | 394 | UPLC |

TABLE 52

| Compound | | M.P. | M.P. |
|---|---|---|---|
| No. | Structural formula | Low (° C.) | High (° C.) |
| 134 | 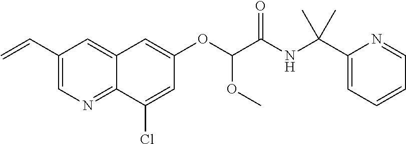 [SMILES: C=Cc1cnc2c(Cl)cc(OC(OC)C(=O)NC(C)(C)c3ccccn3)cc2c1] | 93 | 95 |
| 135 | 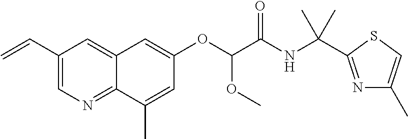 [SMILES: C=Cc1cnc2c(C)cc(OC(OC)C(=O)NC(C)(C)c3nc(C)cs3)cc2c1] | 139 | 141 |
| 136 | 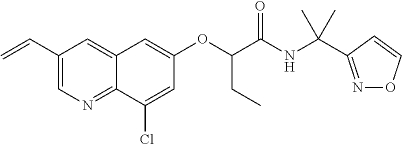 [SMILES: C=Cc1cnc2c(Cl)cc(OC(CC)C(=O)NC(C)(C)c3ccon3)cc2c1] | 104 | 107 |
| 137 | 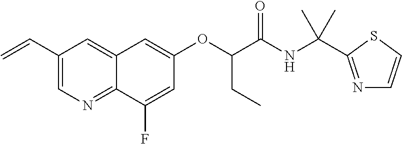 [SMILES: C=Cc1cnc2c(F)cc(OC(CC)C(=O)NC(C)(C)c3nccs3)cc2c1] | 102 | 103 |
| 138 | 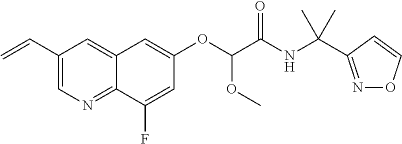 [SMILES: C=Cc1cnc2c(F)cc(OC(OC)C(=O)NC(C)(C)c3ccon3)cc2c1] | 118 | 120 |
| 139 | 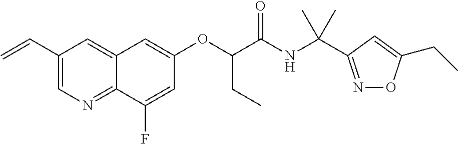 [SMILES: C=Cc1cnc2c(F)cc(OC(CC)C(=O)NC(C)(C)c3cc(CC)on3)cc2c1] | 114 | 116 |
| 140 | 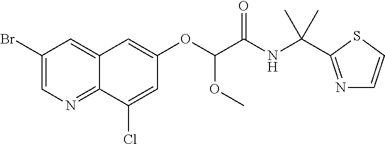 [SMILES: COC(Oc1cc(Cl)c2ncc(Br)cc2c1)C(=O)NC(C)(C)c1nccs1] | 111 | 114 |

### EXAMPLE 7

This Example illustrates the fungicidal properties of compounds of formula (I). Compounds were tested in DMSO solutions against a set of standard screening pathosystems as exemplified below.

### Leaf Disc Tests:

Leaf disks of various plant species (diameter 14 mm) are cut from plants grown in the greenhouse. The cut leaf disks are placed in multiwell plates (24-well format) onto water agar. Immediately after cutting the leaf disks are sprayed with a test solution.

Compounds to be tested are prepared as DMSO solutions (max. 10 mg/ml). Just before spraying the solutions are diluted to the appropriate concentrations with 0.025% Tween20. After drying, the leaf disks are inoculated with a spore suspension of the appropriate pathogenic fungus.

After an incubation time of 3-7 days after inoculation at defined conditions (temp, rH, light, etc.) according to the respective test system, the activity of the test compound is assessed as antifungal activity.

### Liquid Culture Tests:

Mycelia fragments or conidia suspensions of a fungus, prepared either freshly from liquid cultures of the fungus or from cryogenic storage, are directly mixed into nutrient broth. DMSO solutions of the test compound (max. 10 mg/ml) is diluted with 0.025% Tween20 by factor 50 and 10 μl of this solution is pipetted into a microtiter plate (96-well format) and the nutrient broth containing the fungal spores/mycelia fragments is then added to give an end concentration of the tested compound. The test plates are incubated at 24° C. and 96% rH in the dark. The inhibition of fungal growth is determined photometrically after 2-6 days and antifungal activity is calculated.

Phytophthora infestans/Tomato/Leaf Disc Preventative (Late Blight)

Tomato leaf disks are placed on water agar in multiwell plates (24-well format) and sprayed with the formulated test compound diluted in water. The leaf disks are inoculated with a spore suspension of the fungus 1 day after application. The inoculated leaf disks are incubated at 16° C. and 75% rh under a light regime of 24 h darkness followed by 12 h light/12 h darkness in a climate cabinet and the activity of a compound is assessed as percent disease control compared to untreated when an appropriate level of disease damage appears in untreated check leaf disks (5-7 days after application).

Compounds 4, 7, 8, 9, 10, 11, 12, 13, 15, 18, 20, 21, 22, 23, 24, 25, 28, 30, 31, 32, 33, 36, 37, 39, 40, 43, 44, 49, 51, 52, 53, 54, 55, 64, 67, 69, 70, 72, 73, 76, 77, 82, 83, 89, 91, 94, 96, 100, 105, 109, 110, 112, 135, 137 and 139 from Table 49, Table 50, Table 51 and Table 52 according to the invention at 200 ppm inhibit fungal infestation in this test to at least 80%, while under the same conditions untreated control plants are infected by the phytopathogenic fungi to over 80%.

Plasmopara viticola/Grape/Leaf Disc Preventative (Late Blight)

Grape vine leaf disks are placed on water agar in multiwell plates (24-well format) and sprayed with the formulated test compound diluted in water. The leaf disks are inoculated with a spore suspension of the fungus 1 day after application. The inoculated leaf disks are incubated at 19° C. and 80% rh under a light regime of 12 h light/12 h darkness in a climate cabinet and the activity of a compound is assessed as percent disease control compared to untreated when an appropriate level of disease damage appears in untreated check leaf disks (6-8 days after application).

Compounds 7, 8, 9, 10, 11, 12, 13, 15, 16, 17, 18, 19, 20, 21, 22, 23, 24, 26, 28, 29, 30, 32, 33, 36, 38, 39, 41, 43, 44, 45, 49, 50, 51, 52, 53, 54, 56, 61, 62, 64, 66, 67, 68, 69, 71, 72, 73, 75, 76, 77, 78, 82, 83, 89, 91, 94, 96, 99, 100, 103, 104, 105, 108, 109, 110, 119, 120, 134, 135, 137 and 139 from Table 49, Table 50, Table 51 and Table 52 according to the invention at 200 ppm inhibit fungal infestation in this test to at least 80%, while under the same conditions untreated control plants are infected by the phytopathogenic fungi to over 80%.

Blumeria qraminis f. sp. tritici (Erysiphe qraminis f. sp. tritici)/Wheat/Leaf Disc Preventative (Powdery Mildew on Wheat)

Wheat leaf segments cv. Kanzler are placed on agar in a multiwell plate (24-well format) and sprayed with the formulated test compound diluted in water. The leaf disks are inoculated by shaking powdery mildew infected plants above the test plates 1 day after application. The inoculated leaf disks are incubated at 20° C. and 60% rh under a light regime of 24 h darkness followed by 12 h light/12 h darkness in a climate chamber and the activity of a compound is assessed as percent disease control compared to untreated when an appropriate level of disease damage appears on untreated check leaf segments (6-8 days after application).

Compounds 1, 2, 3, 4, 6, 7, 8, 9, 10, 11, 12, 13, 15, 16, 17, 18, 19, 20, 21, 22, 23, 24, 25, 26, 28, 29, 30, 31, 32, 33, 37, 39, 44, 45, 51, 52, 53, 54, 55, 60, 62, 63, 64, 67, 68, 69, 73, 77, 78, 79, 82, 83, 89, 94, 96, 105, 109, 110, 111, 112, 113, 115, 117, 119, 120, 122, 127, 134, 135, 136, 137, 138 and 140 from Table 49, Table 50, Table 51 and Table 52 according to the invention at 200 ppm inhibit fungal infestation in this test to at least 80%, while under the same conditions untreated control plants are infected by the phytopathogenic fungi to over 80%.

Phaeosphaeria nodorum (Septoria nodorum)/Wheat/Leaf Disc Preventative (Glume Blotch)

### Lept—

Wheat leaf segments cv. Kanzler are placed on agar in a multiwell plate (24-well format) and sprayed with the formulated test compound diluted in water. The leaf disks are inoculated with a spore suspension of the fungus 2 days after application. The inoculated test leaf disks are incubated at 20° C. and 75% rh under a light regime of 12 h light/12 h darkness in a climate cabinet and the activity of a compound is assessed as percent disease control compared to untreated when an appropriate level of disease damage appears in untreated check leaf disks (5-7 days after application).

Compounds 7, 8, 9, 10, 11, 12, 13, 15, 18, 20, 24, 32, 33, 39, 44, 45, 51, 53, 60, 68, 73, 75, 78, 111, 112, 113, 116, 117 and 135 from Table 49, Table 50, Table 51 and Table 52 according to the invention at 200 ppm inhibit fungal infestation in this test to at least 80%, while under the same conditions untreated control plants are infected by the phytopathogenic fungi to over 80%.

Pythium ultimum/Liquid Culture (Seedling Damping Off)

Mycelia fragments and oospores of a newly grown liquid culture of the fungus are directly mixed into nutrient broth (PDB potato dextrose broth). After placing a (DMSO) solution of test compound into a microtiter plate (96-well format), the nutrient broth containing the fungal mycelia/spore mixture is added. The test plates are incubated at 24° C. and the inhibition of growth is determined photometrically 2-3 days after application.

Compounds 2, 3, 4, 5, 6, 7, 8, 9, 10, 11, 12, 13, 15, 16, 17, 18, 19, 20, 21, 22, 23, 24, 25, 26, 27, 28, 29, 30, 31, 32, 33, 35, 36, 37, 38, 39, 40, 41, 43, 44, 45, 49, 50, 51, 52, 53, 54, 55, 56, 57, 58, 60, 61, 62, 63, 64, 65, 66, 67, 68, 69, 71, 72, 73, 74, 75, 76, 77, 78, 79, 82, 83, 89, 94, 96, 100, 103, 104, 105, 108, 109, 110, 111, 112, 113, 114, 115, 116, 117, 118, 119, 120, 121, 122 and 125, 134, 135, 136, 137 and 139 from Table 49, Table 50, Table 51 and Table 52 according to the invention at 200 ppm inhibit fungal infestation in this test to at least 80%, while under the same conditions untreated control plants are infected by the phytopathogenic fungi to over 80%.

1. A compound of the general formula (I) 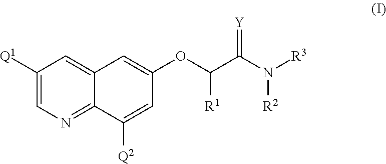
wherein
Q¹ is methyl, ethyl, cyclopropyl, methoxy, methylthio, vinyl, ethynyl, bromo, iodo or thienyl;
Q² is hydrogen, methyl, fluoro or chloro;
R¹ is ethyl, methoxy or methylthio;
R² is hydrogen or methyl;
R³ is —CR⁴R⁵R⁶;
R⁴ and R⁵, independently of each other, are hydrogen, methyl, ethyl, methoxymethyl or cyano,
R⁴ and R⁵ together with the carbon atom to which they are attached form a 3- to 5-membered carbocyclic ring, which is optionally substituted by methyl;
R⁶ is a heteroaryl selected from the group consisting of oxazolyl, isoxazolyl, benzoxazolyl, thiazolyl, isothiazolyl and pyridyl, which heteroaryls are unsubstituted or substituted by C₁₋₄alkyl, C₁₋₄haloalkyl, C₁₋₄hydroxyalkyl, C₁₋₄methoxyalkyl, C₁₋₄alkoxy, phenyl, C₁₋₄-alkoxycarbonyl, halogen or tri(C₁₋₄alkyl)silyl, where when Q¹ is bromo or iodo and R¹ is ethyl or methoxy then R⁶ is different from pyridyl; and
Y is oxygen or sulfur;
or a salt or a N-oxide thereof.

2. A compound according to claim 1, wherein Q¹ is methylthio, vinyl, ethynyl, iodo.

3. A compound according to claim 2, wherein Q¹ is ethynyl.

4. A compound according to claim 1, wherein Q² is hydrogen and methyl.

5. A compound according to claim 1, wherein R¹ is methoxy or methylthio.

6. A compound according to claim 5, wherein R¹ is methylthio.

7. A compound according to claim 1, wherein R² is hydrogen.

8. A compound according to claim 1, wherein R⁴ and R⁵, independently of each other, are hydrogen, methyl or ethyl.

9. A compound according to claim 1, wherein R⁶ is thiazolyl, isothiazolyl, isoxazolyl or pyridyl.

10. A compound according to claim 9, wherein R⁶ is R⁶ is isoxazolyl and pyridyl.

11. A compound according to claim 1, wherein Y is oxygen.

12. A compound according to claim 1, wherein Q¹ is methylthio, vinyl, ethynyl, bromo, iodo or thienyl; Q² is hydrogen, methyl, fluoro or chloro; R¹ is ethyl, methoxy or methylthio; R² is hydrogen; R³ is —CR⁴R⁵R⁶; R⁴ and R⁵, independently of each other, are hydrogen, methyl or ethyl, R⁴ and R⁵ together with the carbon atom to which they are attached form a cyclopropyl group; and R⁶ is a heteroaryl selected from the group consisting of oxazolyl, isoxazolyl, benzoxazolyl, thiazolyl, isothiazolyl and pyridyl, which heteroaryls are unsubstituted or substituted by methyl, ethyl, trifluormethyl, hydroxymethyl, methoxymethyl, methoxy, ethoxy, phenyl, methoxycarbonyl, halogen or trimethylsilyl.

13. A compound according to claim 1, wherein Q¹ is methylthio, vinyl, ethynyl or iodo; Q² is hydrogen, methyl, chloro or fluoro; R¹ is methylthio; R² is hydrogen; R³ is —CR⁴R⁵R⁶; R⁴ and R⁵, independently of each other, are hydrogen, methyl or ethyl, and R⁶ is a heteroaryl selected from the group consisting of isoxazolyl, thiazolyl, isothiazolyl and pyridyl.

14. A compound according to claim 1, wherein Q¹ is methylthio, vinyl, ethynyl or iodo; Q² is hydrogen, methyl, chloro or fluoro; R¹ is methoxy; R² is hydrogen; R³ is —CR⁴R⁵R⁶; R⁴ and R⁵, independently of each other, are hydrogen, methyl or ethyl, and R⁶ is a heteroaryl selected from the group consisting of isoxazolyl, thiazolyl, isothiazolyl and pyridyl.

15. A fungicidal composition comprising a fungicidally effective amount of a compound of formula (1) according to claim 1, a suitable carrier or diluent therefore, and optionally a further fungicidal compound.

16. A method of combating or controlling phytopathogenic fungi which comprises applying a fungicidally effective amount of a compound of formula (I) according to claim 1 to a plant, to a seed of a plant, to the locus of the plant or seed or to soil or any other plant growth medium.
